(19) United States
(12) Patent Application Publication
(10) Pub. No.: US 2016/0075110 A1
(43) Pub. Date: Mar. 17, 2016

(54) FLEXIBLE SUBSTRATE AND METHOD FOR PRODUCING SAME, GLASS LAMINATE AND METHOD FOR PRODUCING SAME, AND METHOD FOR PRODUCING ELECTRONIC DEVICE

(71) Applicant: ASAHI GLASS COMPANY, LIMITED, Tokyo (JP)

(72) Inventors: Junichi KAKUTA, Tokyo (JP); Kenichi Ebata, Tokyo (JP); Tatsuya Miyajima, Tokyo (JP); Yoji Nakajima, Tokyo (JP); Yuki Ishikawa, Tokyo (JP)

(73) Assignee: ASAHI GLASS COMPANY, LIMITED, Tokyo (JP)

(21) Appl. No.: 14/953,868

(22) Filed: Nov. 30, 2015

Related U.S. Application Data
(63) Continuation of application No. PCT/JP2014/063080, filed on May 16, 2014.

(30) Foreign Application Priority Data
May 28, 2013 (JP) 2013-112319
Feb. 25, 2014 (JP) 2014-034438

(51) Int. Cl. B32B 17/10; C09D 179/08; B32B 38/10

(52) U.S. Cl. CPC B32B 17/10; B32B 38/10; C09D 179/08

(57) ABSTRACT

The present invention relates to a flexible substrate and particularly relates to a flexible substrate which includes a resin layer of a polyimide resin produced using a predetermined method. Further, the present invention relates to a method for producing the flexible substrate, a glass laminate which includes the flexible substrate and a method for producing the same, and a method for producing an electronic device.

### TECHNICAL FIELD

The present invention relates to a flexible substrate and particularly relates to a flexible substrate which includes a resin layer of a polyimide resin produced using a predetermined method.

Further, the present invention relates to a method for producing the flexible substrate, a glass laminate which includes the flexible substrate and a method for producing the same, and a method for producing an electronic device.

### BACKGROUND ART

In recent years, a flexible electronic device that uses a glass substrate of a thin film has been attracting attention. A wristwatch, a human body mounted type display device, or a display device which can be arranged in a curved portion of an object has been suggested. Such a flexible device can be accommodated by rolling up the device itself and is basically suitable for an ultrathin and lightweight mobile machine because the flexible device is lightweight and can be bent.

Further, the application thereof is not limited to a small-sized device and the flexible device can be used for a large-sized display.

Meanwhile, in display devices such as a liquid crystal display and an organic electroluminescence display which are currently widely used, a production technique of forming an element on a glass substrate has been established. However, when a flexible electronic device is intended to be manufactured, the device cannot be manufactured using a manufacturing method made in assumption of an ordinary glass substrate because of low rigidity of the substrate itself.

Here, as a method for solving the above-described problem, Patent Document 1 suggests a method of preparing a glass laminate obtained by laminating a flexible substrate which includes a glass substrate and a polyimide film with a reinforcing plate, forming an electronic device member such as a display device on the glass substrate of the glass laminate, and then separating the reinforcing plate from the flexible substrate. Further, in Patent Document 1, the reinforcing plate includes a support glass and a silicone resin layer fixed onto the support glass, and the silicone resin layer is peelably adhered to the flexible substrate.

### BACKGROUND ART DOCUMENT

### Patent Document

Patent Document 1: WO 2011/024690

### SUMMARY OF THE INVENTION

### Problems that the Invention is to Solve

With regard to the glass laminate including the glass substrate described in Patent Document 1, improved heat resistance has been currently demanded. As the function of an electronic device member to be formed on the glass substrate of the glass laminate becomes advanced or the member thereof becomes complicated, the temperature at which the electronic device member is formed becomes higher and the time for which the member thereof is exposed to the high temperature becomes longer in many cases.

The glass laminate described in Patent Document 1 withstands a treatment in air at 350° C. for 1 hour. However, according to the examination of the present inventors, in a case where a glass laminate prepared by referring to Patent Document 1 was subjected to a treatment at 400° C. for 1 hour, when a flexible substrate was peeled off from the surface of a silicone resin layer, the flexible substrate was not peeled off from the surface of the silicone resin layer and a part thereof is destroyed or a part of the resin of the silicone resin layer remained on the flexible substrate, and thus the productivity of the electronic device was degraded in some cases.

Further, under the above-described heating conditions, foaming or whitening is caused by decomposition of the silicone resin layer. When decomposition of the silicone resin layer is caused, there is a concern that impurities may be mixed into the electronic device when the electronic device is manufactured on the glass substrate and thus the yield of the electronic device may be decreased.

When the flexible substrate including the glass substrate and a polyimide film described in Patent Document 1 is arranged on support glass from which a silicone resin layer is removed and the characteristics thereof were evaluated by the present inventors, it was found that adhesiveness of the flexible substrate to the support glass was not sufficient. In the case where the adhesiveness of the flexible substrate to the support glass is not sufficient, positional displacement of the flexible substrate occurs when an electronic device is produced on the glass substrate in the flexible substrate, and thus there is a concern that the yield of the electronic device may be decreased.

The present invention has been made in consideration of the above-described problems and an object thereof is to provide a flexible substrate which can be easily peeled off from a support glass to be laminated even after a heat treatment is carried out at a high temperature and in which decomposition of the resin layer is suppressed.

Further, another object of the present invention is to provide a glass laminate from which the flexible substrate can be easily peeled off even after the heat treatment is carried out at a high temperature and in which decomposition of the resin layer is suppressed and positional displacement of the flexible substrate is unlikely to occur.

Further, still another object of the present invention is to provide a method for producing the flexible substrate, a method for producing the glass laminate, and a method for producing the electronic device.

### Means for Solving the Problems

As a result of intensive research conducted by the present inventors for the purpose of solving the above-described problems, the present invention has been completed.

Namely, a first embodiment of the present invention is a flexible substrate including: a glass substrate; and a layer of a polyimide resin which is formed on the glass substrate, in which the flexible substrate is used for producing a glass laminate by laminating a support glass on the layer of the polyimide resin, the polyimide resin in the flexible substrate is a polyimide resin which is formed of a repeating unit that is represented by Formula (1) which will be described later and includes residues (X) of tetracarboxylic acids and residues (A) of diamines and in which 50% by mole or greater of a total number of the residues (X) of tetracarboxylic acids is formed of at least one group selected from the group consisting of groups represented by Formulae (X1) to (X4) which will be described later and 50% by mole or greater of a total number of the residues (A) of diamines is formed of at least one group selected from the group consisting of groups represented by Formulae (A1) to (A7) which will be described later, and the layer of the polyimide resin on the glass substrate is a layer of a polyimide resin formed by subjecting a layer (I) of a curable resin which is to be the polyimide resin through thermal curing or a layer (II) obtained by being coated with a composition containing the polyimide resin and a solvent, the layers (I) and (II) being formed on the glass substrate, to a first heat treatment of heating in a temperature range of 60° C. or more and lower than 250° C. and a second heat treatment of heating in a temperature range of 250° C. to 500° C. in this order.

In the first embodiment, in the polyimide resin, it is preferable that 80% by mole to 100% by mole of the total number of the residues (X) of tetracarboxylic acids is formed of at least one group selected from the group consisting of groups represented by the Formulae (X1) to (X4) which will be described later, and 80% by mole to 100% by mole of the total number of the residues (A) of diamines is formed of at least one group selected from the group consisting of groups represented by the Formulae (A1) to (A7) which will be described later.

In the first embodiment, it is preferable that the layer of the polyimide resin has a thickness in a range of 0.1 μm to 100 μm.

In the first embodiment, it is preferable that a surface roughness Ra of an exposed surface of the layer of the polyimide resin is in a range of 0 nm to 2.0 nm.

A second embodiment of the present invention is a glass laminate including: the flexible substrate according to the first embodiment; and a support glass which is laminated on a surface of the layer of the polyimide resin of the flexible substrate.

A third embodiment of the present invention is a method for producing a flexible substrate, including: forming a layer of a curable resin which is to be the following polyimide resin through thermal curing on a glass substrate, and subjecting the layer to a first heat treatment of heating in a temperature range of 60° C. or more and lower than 250° C. and a second heat treatment of heating in a temperature range of 250° C. to 500° C. in this order to convert the curable resin into the following polyimide resin, thereby forming a layer of the polyimide resin:

the polyamide resin: a polyimide resin which is formed of a repeating unit that is represented by Formula (1) which will be described later and includes residues (X) of tetracarboxylic acids and residues (A) of diamines and in which 50% by mole or greater of a total number of the residues (X) of tetracarboxylic acids is formed of at least one group selected from the group consisting of groups represented by Formulae (X1) to (X4) which will be described later and 50% by mole or greater of a total number of the residues (A) of diamines is formed of at least one group selected from the group consisting of groups represented by the following Formulae (A1) to (A7) which will be described later.

In the third embodiment, in the polyimide resin, it is preferable that 80% by mole to 100% by mole of the total number of the residues (X) of tetracarboxylic acids is formed of at least one group selected from the group consisting of groups represented by the Formulae (X1) to (X4) which will be described later, and 80% by mole to 100% by mole of the total number of the residues (A) of diamines is formed of at least one group selected from the group consisting of groups represented by the Formulae (A1) to (A7) which will be described later.

In the third embodiment, it is preferable that the layer of the polyimide resin has a thickness in a range of 0.1 μm to 100 μm.

In the third embodiment, it is preferable that the layer of the curable resin is formed by coating a solution of the curable resin on the glass substrate to form a coating film of the solution, and then removing a solvent from the coating film during the first heat treatment.

In the third embodiment, it is preferable that the curable resin contains polyamic acid obtained by reacting a tetracarboxylic dianhydride with diamines, at least a part of the tetracarboxylic dianhydride is formed of at least one tetracarboxylic dianhydride selected from the group consisting of compounds represented by Formulae (Y1) to (Y4) which will be described later, and at least a part of the diamines is formed of at least one diamine selected from the group consisting of compounds represented by Formulae (B1) to (B7) which will be described later.

A fourth embodiment of the present invention is a method for producing a flexible substrate, including: forming a layer obtained by coating a composition containing the following polyimide resin and a solvent on a glass substrate, and subjecting the layer to a first heat treatment of heating in a temperature range of 60° C. or more and lower than 250° C. and a second heat treatment of heating in a temperature range of 250° C. to 500° C. in this order, thereby producing a flexible substrate which comprises the glass substrate and a layer of the polyimide resin formed on the glass substrate:

the polyamide resin: a polyimide resin which is formed of a repeating unit that is represented by Formula (1) which will be described later and includes residues (X) of tetracarboxylic acids and residues (A) of diamines and in which 50% by mole or greater of a total number of the residues (X) of tetracarboxylic acids is formed of at least one group selected from the group consisting of groups represented by Formulae (X1) to (X4) which will be described later and 50% by mole or greater of a total number of the residues (A) of diamines is formed of at least one group selected from the group consisting of groups represented by Formulae (A1) to (A7) which will be described later.

A fifth embodiment of the present invention is a method for producing an electronic device, including: a member forming step of forming an electronic device member on a glass substrate surface on which the polyimide resin is not laminated, in the glass laminate according to the second embodiment, thereby obtaining an electronic device member-attached laminate; and

a separation step of removing the support glass from the electronic device member-attached laminate, thereby obtaining an electronic device which includes the flexible substrate and the electronic device member.

### Advantage of the Invention

According to the present invention, it is possible to provide a glass laminate from which a flexible substrate can be easily peeled off even after the heat treatment is carried out at a high temperature and in which decomposition of a resin layer is suppressed and positional displacement of the flexible substrate is unlikely to occur.

Further, according to the present invention, it is possible to provide a flexible substrate used for producing the glass laminate.

Further, according to the present invention, it is also possible to provide a method for producing the glass laminate, a method for producing the flexible substrate, and a method for producing an electronic device.

### BRIEF DESCRIPTION OF THE DRAWINGS

FIG. 1 is a sectional view schematically illustrating a flexible substrate according to an embodiment of the present invention.

FIG. 2 is a sectional view schematically illustrating a glass laminate according to an embodiment of the present invention.

FIGS. 3A to 3D are sectional views schematically and sequentially illustrating steps of a method for producing a member-attached glass substrate according to an embodiment of the present invention.

FIG. 4 is a view schematically illustrating bonding procedures using a roll laminator in Examples.

### MODE FOR CARRYING OUT THE INVENTION

Hereinafter, embodiments of the present invention will be described with reference to the accompanying drawings, but the present invention is not limited to the embodiments described below and various modifications and replacements can be added to the embodiments without departing from the range of the present invention.

A flexible substrate and a glass laminate of the present invention have a characteristic in which a layer of a polyimide resin (hereinafter, also simply referred to as a “resin layer”) having a predetermined structure is used. Further, the resin layer is produced by carrying out a predetermined heat treatment. When such a resin layer is used, heat resistance at the time of the heat treatment becomes excellent, adhesiveness to a support glass becomes excellent, an increase in peeling strength between the support glass and the resin layer even after the heat treatment is unlikely to occur, and the flexible substrate can be easily peeled off. In addition, the adhesiveness of the resin layer to the support glass becomes also excellent.

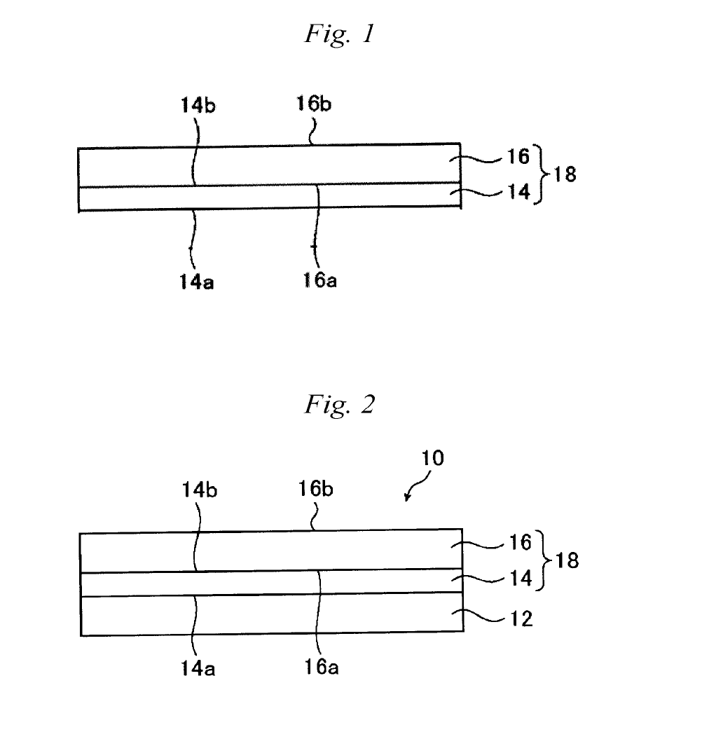

FIG. 1 is a sectional view schematically illustrating an example of a flexible substrate 18 according to the present invention.

As illustrated in FIG. 1, the flexible substrate 18 is a laminate including a layer 14 of a polyimide resin which has a predetermined structure formed on a glass substrate 16. In the layer 14 of the polyimide resin, a surface 14b is in contact with a first main surface of the glass substrate 16 and other materials are not in contact with a surface 14a.

The flexible substrate 18 is normally used for a member forming step of producing an electronic device member such as a liquid crystal panel on the glass substrate 16 by laminating the surface 14a of the layer of the polyimide resin and the support glass 12 such that the surface 14a is brought into direct contact with the support glass 12 as illustrated in FIG. 2.

FIG. 2 is a sectional view schematically illustrating an example of the glass laminate according to the present invention.

As illustrated in FIG. 2, the glass laminate 10 is a laminate in which a layer of the support glass 12, a layer of the glass substrate 16, and the resin layer 14 positioned therebetween are present. In the resin layer 14, one surface 14a is in contact with the layer of the support glass 12 and another surface 14b is in contact with the first main surface 16a of the glass substrate 16.

The support glass 12 reinforces the flexible substrate 18 in the member forming step of producing an electronic device member such as a liquid crystal panel.

The glass laminate 10 is used until the member forming step described below is performed. That is, the glass laminate 10 is used until the electronic device member such as a liquid crystal display device is formed on a surface of a second main surface 16b of the glass substrate 16. Thereafter, the glass laminate on which the electronic device member is formed is divided into the support glass 12 and the member-attached glass substrate, and the support glass 12 does not becomes a portion constituting an electronic device. The support glass 12 is laminated with a new flexible substrate 18 and can be re-used as a new glass laminate 10.

Further, the resin layer 14 is fixed to the glass substrate 16 and the flexible substrate 18 is peelably laminated on (adhered to) the support glass 12 such that the resin layer 14 in the flexible substrate 18 is brought into direct contact with the support glass 12. In the present invention, there is a difference in peeling strength (that is, a stress required for peeling) between the fixation and the peelable adhesion and the fixation means that the peeling strength thereof is larger than that of the adhesion. That is, the peeling strength at the interface between the resin layer 14 and the glass substrate 16 becomes larger than the peeling strength at the interface between the resin layer 14 and the support glass 12. In other words, the peelable lamination (adhesion) means that a layer can be peeled and also can be peeled without causing the fixed surface to be peeled.

More specifically, when the interface between the glass substrate 16 and the resin layer 14 has peeling strength (x) and a stress in a peeling direction which exceeds the peeling strength (x) is applied to the interface between the glass substrate 16 and the resin layer 14, peeling occurs at the interface between the glass substrate 16 and the resin layer 14. When the interface between the resin layer 14 and the support glass 12 has peeling strength (y) and a stress in a peeling direction which exceeds the peeling strength (y) is applied to the interface between the resin layer 14 and the support glass 12, peeling occurs at the interface between the resin layer 14 and the support glass 12.

In the glass laminate 10 (also indicating an electronic device member-attached laminate described below), the peeling strength (x) is larger than the peeling strength (y). Therefore, when a stress in a direction in which the support glass 12 and the glass substrate 16 are peeled is applied to the glass laminate 10, the glass laminate 10 of the present invention is peeled at the interface between the resin layer 14 and the support glass 12 and is divided into the flexible substrate 18 and the support glass 12.

It is preferable that the peeling strength (x) is sufficiently larger than the peeling strength (y). An increase in the peeling strength (x) means that adhesion force of the resin layer 14 to the glass substrate 16 is increased and adhesion force which is relatively higher than that to the support glass 12 after the heat treatment can be maintained.

For example, a method of forming the resin layer 14 on the glass substrate 16 (preferably a method of forming a predetermined resin layer 14 by curing a curable resin which is to be a polyimide resin formed of a repeating unit represented by Formula (1) through thermal curing on the glass substrate 16) is performed for the purpose of increasing the adhesion force of the resin layer 14 to the glass substrate 16. The resin layer 14 bonded to the glass substrate 16 with high binding force thereto can be formed using adhesion force at the time of curing.

In addition, the binding force of the cured resin layer 14 with respect to the support glass 12 is normally smaller than the binding force generated at the time of the curing. Therefore, the glass laminate 10 satisfying a desired peeling relationship can be produced by forming the resin layer 14 on the glass substrate 16 and then laminating the support glass 12 on the surface of the resin layer 14.

Hereinafter, first, respective layers (the support glass 12, the glass substrate 16, and the resin layer 14) constituting the flexible substrate 18 and the glass laminate 10 will be described in detail and then methods for producing the glass laminate and the member-attached glass substrate will be described in detail.

[Support Glass]

The support glass 12 is not particularly limited as long as the support glass supports the flexible substrate 18 through the resin layer 14 described below and reinforces the strength of the flexible substrate 18. The composition of the support glass 12 is not particularly limited and as the composition, for example, glass containing an alkali metal oxide (soda lime glass or the like) or glass having various compositions such as alkali-free glass can be used. Among these, alkali-free glass is preferable in view of the small thermal shrinkage ratio. It is preferable that the surface of the support glass is washed in advance before adhesion to the resin layer 14 for the purpose of removing dirt or foreign matters.

The thickness of the support glass 12 is not particularly limited, but the thickness in a level in which the glass laminate 10 of the present invention can be treated in the current production line of a panel for an electronic device is preferable. For example, the thickness of a glass substrate being used for a current LCD is mainly in the range of 0.4 mm to 1.2 mm and particularly 0.7 mm in many cases. In the present invention, it is assumed that a film-like flexible substrate which is thinner than the glass substrate being used for a current LCD is used. In this case, when the total thickness of the glass laminate 10 is the same as that of the current glass substrate, the thickness thereof is easily suitable for the current production line.

For example, in a case where the current production line is designed to treat a substrate having a thickness of 0.5 mm and the thickness of the flexible substrate 18 is 0.1 mm, the thickness of the support glass 12 is set to 0.4 mm. In addition, the current production line which is designed to treat a glass substrate having a thickness of 0.7 mm is the most common and, for example, the thickness of the support glass 12 is set to 0.5 mm when the thickness of the flexible substrate 18 is 0.2 mm.

The flexible substrate 18 of the present invention is not limited to a liquid crystal display device and the purpose of the flexible substrate of the present invention is also to make a solar power panel or the like have flexibility or the like. Accordingly, the thickness of the support glass 12 is not limited, but the thickness thereof is preferably in the range of 0.1 mm to 1.1 mm. Moreover, it is preferable that the thickness of the support glass 12 is greater than that of the flexible substrate 18 for the purpose of securing the rigidity. Further, the thickness of the support glass 12 is preferably 0.3 mm or greater, more preferably in the range of 0.3 mm to 0.8 mm, and still more preferably in the range of 0.4 mm to 0.7 mm.

The surface of the support glass 12 may be a polished surface which is subjected to a treatment of mechanical polishing or chemical polishing or may be a non-etched surface (original surface) which is not subjected to a polishing treatment. In view of productivity and the cost, it is preferable that the surface of the support glass 12 is a non-etched surface (original surface).

The support glass 12 includes a first main surface and a second main surface and it is preferable that the shape thereof, which is not particularly limited, is a rectangle. Here, the rectangle is substantially an approximate rectangle and includes a shape obtained by cutting off the corners of the peripheral portion (corner-cut shape). In a case of a rectangle, the size of the support glass 12, which is not particularly limited, may be in the range of 100 mm to 2000 mm×100 mm to 2000 mm and is preferably in the range of 500 mm to 1000 mm×500 mm to 1000 mm.

[Glass Substrate]

In the glass substrate 16, the first main surface 16a is brought into contact with the resin layer 14 and an electronic device member is provided on the second main surface 16b on the opposite side to the resin layer 14 side. That is, the glass substrate 16 is a substrate used to form an electronic device described below.

The kind of the glass substrate 16 may be general and a glass substrate for a display device such as an LCD or an OLED is exemplified. The glass substrate 16 has excellent chemical resistance, excellent resistance to moisture permeability, and a low thermal shrinkage ratio. As an index of the thermal shrinkage ratio, a linear expansion coefficient regulated in JIS R 3102 (amended in 1995) is used.

Since the member forming step is frequently accompanied by the heat treatment, various inconveniences easily occur when the linear expansion coefficient of the glass substrate 16 is large. For example, in a case where TFT is formed on the glass substrate 16, there is a concern that positional displacement of TFT becomes excessive due to thermal shrinkage of the glass substrate 16 when the glass substrate 16 on which TFT is formed under the condition of heating is cooled.

The glass substrate 16 is obtained by melting glass raw materials and molding molten glass to have a plate shape. A normal method may be used as such a molding method, and examples thereof include a float process, a fusion process, a slot down draw process, a Fourcault process, and a Lubbers process. Further, the glass substrate 16 having a particularly small thickness is obtained by performing molding using a process (re-draw process) of heating glass which is temporarily molded to have a plate shape at a temperature at which glass can be molded and stretching the glass by means of extension or the like to be thinned.

The kind of the glass of the glass substrate 16 is not particularly limited, but oxide-based glass including alkali-free borosilicate glass, borosilicate glass, soda-lime glass, high silica glass, and other glasses containing silicon oxides as main components is preferable. As the oxide-based glass, glass containing 40% by mass to 90% by mass of silicon oxide in terms of oxide is preferable.

As the glass of the glass substrate 16, glass suitable for the kind of an electronic device member or the production method thereof is employed. Since elution of alkali metal components easily affects liquid crystals, the glass substrate for a liquid crystal panel is formed of glass which does not substantially contain alkali metal components (alkali-free glass) (in this case, alkaline-earth metal components are normally included). In this manner, the glass of the glass substrate 16 is suitably selected based on the kind of a device to be used and the production method thereof.

The thickness of the glass substrate 16 is preferably 0.3 mm or less, more preferably 0.15 mm or less, and still more preferably 0.10 mm or less from viewpoints of thickness reduction and/or weight reduction of the glass substrate 16. In a case where the thickness of the glass substrate 16 is 0.3 mm or less, excellent flexibility can be provided for the glass substrate 16. In a case where the thickness of the glass substrate 16 is 0.15 mm or less, the glass substrate 16 can be rolled in a roll shape.

In addition, the thickness of the glass substrate 16 is preferably 0.03 mm or greater because the glass substrate 16 is easily produced and easily handled.

In addition, the glass substrate 16 may be formed of two or more layers and, in this case, materials forming the respective layers may be the same as or different from each other. Further, in this case, the “thickness of the glass substrate 16” means the total thickness of all the layers.

[Resin Layer]

The resin layer 14 prevents positional displacement of the flexible substrate 18 until an operation of separating the glass substrate 16 from the support glass 12 is performed and also prevents destruction of the flexible substrate 18 due to the separation operation. The surface 14a of the resin layer 14, which is to be in contact with the support glass 12 is peelably laminated with (adhered to) the first main surface of the support glass 12. The resin layer 14 is bonded to the first main surface of the support glass 12 with weak binding force and the peeling strength (y) of the interface therebetween is weaker than the peeling strength (x) of the interface between the resin layer 14 and the glass substrate 16.

That is, when the glass substrate 16 and the support glass 12 are separated from each other, the glass substrate 16 and the support glass 12 are peeled off at the interface between the first main surface of the support glass 12 and the resin layer 14, but the glass substrate 16 and the support glass 12 are unlikely to be peeled off at the interface between the glass substrate 16 and the resin layer 14. For this reason, the resin layer 14 is adhered to the first main surface of the support glass 12, but has surface characteristics in which the support glass 12 can be easily peeled off. That is, the resin layer 14 prevents positional displacement of the flexible substrate 18 by being bonded to the first main surface of the support glass 12 using a certain degree of binding force and is also bonded thereto to the extent that the flexible substrate 18 can be easily peeled off without being destroyed. In the present invention, the properties of the surface of the resin layer 14 which can be easily peeled off are referred to as peelability. The first main surface of the glass substrate 16 and the resin layer 14 are bonded to each other through binding force in the extent that the first main surface thereof is relatively unlikely to be peeled off from the resin layer 14.

Further, the binding force of the interface between the resin layer 14 and the support glass 12 may be changed before or after an electronic device member is formed on the surface (second main surface 16b) of the glass substrate 16 of the glass laminate 10 (that is, the peeling strength (x) or the peeling strength (y) may be changed). However, the peeling strength (y) is weaker than the peeling strength (x) even after the electronic device member is formed.

It is considered that the resin layer 14 and the layer of the support glass 12 are bonded to each other through binding force resulting from weak adhesion force or van der Waals force. In a case where the resin layer 14 is formed and then the support glass 12 is laminated on the surface thereof, it is considered that the resin layer 14 is bonded to the layer of the glass substrate 16 through binding force resulting from van der Waals force when a polyimide resin in the resin layer 14 is imidized sufficient enough not to exhibit adhesion force. However, the polyimide resin in the resin layer 14 has a certain degree of weak adhesion force in many cases. Even in a case where the adhesiveness is extremely degraded, it is considered that polyimide in the resin layer 14 is adhered to the support glass 12 by carrying out a heating operation when the glass laminate 10 is produced and then an electronic device member is formed on the glass laminate and thus the binding force between the resin layer 14 and the layer of the support glass 12 is increased.

In some cases, the resin layer 14 and the support glass 12 can be laminated with each other by applying a treatment of weakening binding force to the surface of the resin layer 14 before lamination and the first main surface of the support glass 12 before lamination. The binding force of the interface between the resin layer 14 and the support glass 12 is weakened and then the peeling strength (y) can be weakened by performing a non-adhesive treatment on the surface to be laminated and then laminating the resin layer and the support glass.

Moreover, the resin layer 14 is bonded to the surface of the glass substrate 16 through strong binding force such as adhesion force or viscosity. As described above, for example, the layer of the heated and cured polyimide resin is bonded to the surface of the glass substrate 16 and thus strong binding force can be obtained by forming the resin layer 14 on the support glass 12 (preferably, a curable resin which is to be a polyimide resin formed of a repeating unit represented by Formula (1) is cured on the surface of the glass substrate 16 through thermal curing). The binding force between the surface of the glass substrate 16 and the resin layer 14 can be increased by performing a treatment (for example, a treatment of using a coupling agent) of generating strong binding force between the surface of the glass substrate 16 and the resin layer 14.

The binding of the resin layer 14 with the layer of the glass substrate 16 using strong binding force means that the peeling strength (x) of the interface therebetween is high.

The thickness of the resin layer 14, which is not particularly limited, is preferably in the range of 0.1 μm to 100 μm, more preferably in the range of 0.5 μm to 50 μm, and still more preferably in the range of 1 μm to 20 μm. When the thickness of the resin layer 14 is in the above-described range, it is possible to prevent generation of distortion defect of the glass substrate 16 even when bubbles or foreign matters are present between the resin layer 14 and the support glass 12. In addition, when the thickness of the resin layer 14 is extremely large, a long time and materials are needed for formation, which is not economical, and heat resistance is degraded in some cases. Further, when the thickness of the resin layer 14 is too small, adhesiveness of the resin layer 14 to the support glass 12 is degraded in some cases.

In addition, the resin layer 14 may be formed of two or more layers. In this case, the “thickness of the resin layer 14” indicates the total thickness of all layers.

A surface roughness Ra of the surface of the resin layer 14 on the support glass 12 side is preferably in the range of 0 nm to 2.0 nm, more preferably in the range of 0 nm to 1.0 nm, and still more preferably in the range of 0.05 nm to 0.5 nm. When the surface roughness Ra is in the above-described range, the adhesiveness of the flexible substrate 18 to the support glass 12 becomes excellent and thus positional displacement of the flexible substrate 18 is unlikely to occur.

Examples of a method of molding a polyimide resin to have a layered shape include a method of producing a thermoplastic polyimide resin and applying extrusion molding thereto and a method of coating a substrate with a solution containing a curable resin which is to be a polyimide resin through thermal curing to be cured on the surface of a substrate. In the present invention, the resin layer 14 whose surface roughness Ra is in the above-described range can be easily obtained by performing molding according to the latter method.

Here, the surface roughness Ra is measured using an atomic force microscope (manufactured by Pacific Nanotechnology, Inc., Nano Scope Ma; Scan Rate 1.0 Hz, Sample Lines 256, Off-line Modify Flatten order-2, Planefit order-2). (in accordance with the method of measuring the surface roughness of a fine ceramic thin film using an atomic force microscope, JIS R 1683:2007)

The polyimide resin of the resin layer 14 is formed of a repeating unit which is represented by following Formula (1) and includes a residue (X) of tetracarboxylic acids and a residue (A) of diamines. In addition, the polyimide resin contains the repeating unit represented by the Formula (1) as a main component (the content of the repeating unit is preferably 95% by mole or greater with respect to the entirety of repeating units), but may contain another repeating unit other than the above-mentioned repeating unit (for example, a repeating unit represented by the following Formula (2-1) or (2-2)).

Moreover, the residue (X) of tetracarboxylic acids indicates a tetracarboxylic acid residue obtained by removing a carboxy group from tetracarboxylic acids and the residue (A) of diamines indicates a diamine residue obtained by removing an amino group from diamines.

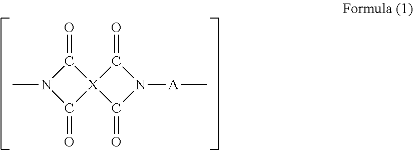

(In Formula (1), X represents a tetracarboxylic acid residue obtained by removing a carboxy group from tetracarboxylic acids and A represents a diamine residue obtained by removing an amino group from diamines.)

In Formula (1), X represents a tetracarboxylic acid residue obtained by removing a carboxy group from tetracarboxylic acids and 50% by mole or greater of the total number of X's is formed of at least one group selected from the group consisting of groups represented by the following Formulae (X1) to (X4). Among these, it is preferable that 80% by mole to 100% by mole of the total number of X's is formed of at least one group selected from the group consisting of groups represented by the following Formulae (X1) to (X4) from the standpoint that peelability of the flexible substrate 18 and the support glass 12 and heat resistance of the resin layer 14 are more excellent and it is more preferable that substantially the whole number (100% by mole) of X's is formed of at least one group selected from the group consisting of groups represented by the following Formulae (X1) to (X4).

Meanwhile, in a case where less than 50% by mole of the total number of X's is formed of at least one group selected from the group consisting of groups represented by the following Formulae (X1) to (X4), at least one of the peelability of the flexible substrate 18 and the support glass 12 and the heat resistance of the resin layer 14 is degraded.

Further, A represents a diamine residue obtained by removing an amino group from diamines and 50% by mole or greater of the total number of A's represents at least one group selected from the group consisting of groups represented by Formulae (A1) to (A7). Among these, it is preferable that 80% by mole to 100% by mole of the total number of A's is formed of at least one group selected from the group consisting of groups represented by the following Formulae (A1) to (A7) from the standpoint that peelability of the flexible substrate 18 and the support glass 12 and heat resistance of the resin layer 14 are more excellent and it is more preferable that substantially the total number (100% by mole) of A's is formed of at least one group selected from the group consisting of groups represented by the following Formulae (A1) to (A7).

Meanwhile, in a case where less than 50% by mole of the total number of A's is formed of at least one group selected from the group consisting of groups represented by the following Formulae (A1) to (A7), at least one of the peelability of the flexible substrate 18 and the support glass 12 and the heat resistance of the resin layer 14 is degraded.

Further, from the standpoint that peelability of the flexible substrate 18 and the support glass 12 and heat resistance of the resin layer 14 are more excellent, it is preferable that 80% by mole to 100% by mole of the total number of X's is formed of at least one group selected from the group consisting of groups represented by the following Formulae (X1) to (X4) and 80% by mole to 100% by mole of the total number of A's is formed of at least one group selected from the group consisting of groups represented by the following Formulae (A1) to (A7) and more preferable that substantially the whole number (100% by mole) of X's is formed of at least one group selected from the group consisting of groups represented by the following Formulae (X1) to (X4) and substantially the whole number (100% by mole) of A's is formed of at least one group selected from the group consisting of groups represented by the following Formulae (A1) to (A7).

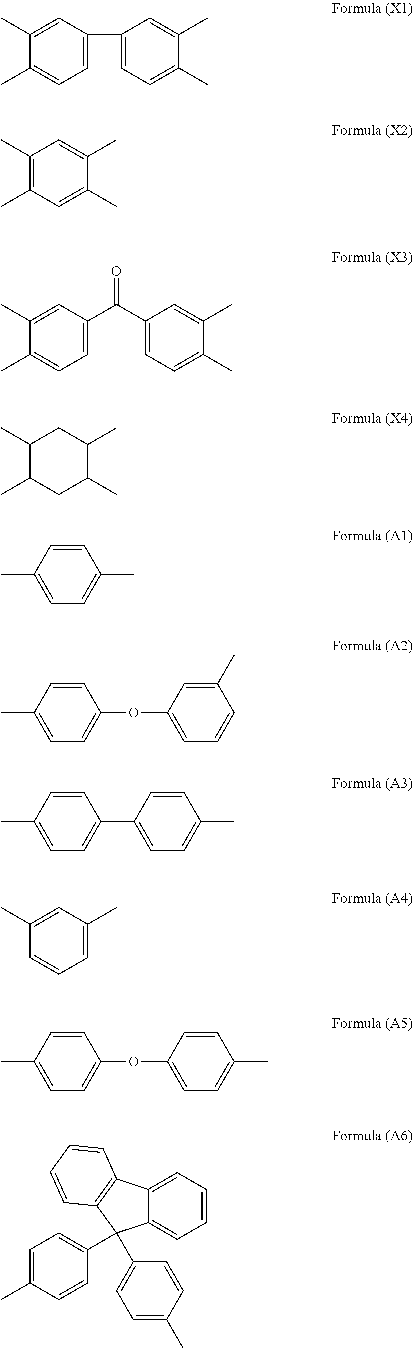

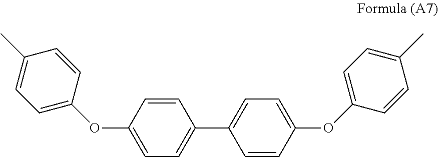

Among these, as X, a group represented by Formula (X1) or a group represented by Formula (X2) is preferable and a group represented by Formula (X1) is more preferable from the standpoint that the peel ability of the flexible substrate 18 and the support glass 12 and the heat resistance of the resin layer 14 are more excellent.

In addition, as A, a group selected from a group consisting of groups represented by Formulae (A1) to (A4) is preferable and a group selected from the group consisting of groups represented by Formulae (A1) to (A3) is more preferable from the standpoint that the peelability of the flexible substrate 18 and the support glass 12 and the heat resistance of the resin layer 14 are more excellent.

As a polyimide resin formed of a suitable combination of groups represented by Formulae (X1) to (X4) and groups represented by Formulae (A1) to (A7), a polyimide resin in which X is a group selected from the group consisting of a group represented by Formula (X1) and a group represented by Formula (X2) and A is a group selected from the group consisting of groups represented by Formulae (A1) to (A5) is exemplified. Further, preferably, a polyimide resin 1 in which X is a group represented by Formula (X1) and A is a group represented by Formula (A1) and a polyimide resin 2 in which X is a group represented by Formula (X2) and A is a group represented by Formula (A5) are exemplified. The polyimide resin 1 and the polyimide resin 2 are preferable in view of heat resistance maintaining for a long period of time in an environment of 450° C. and the polyimide resin 1 is more preferable in view of heat resistance maintaining for a long period of time in an environment of 500° C.

Moreover, as a polyimide resin, a combination of groups, in a case where X is a group represented by Formula (X4) and A is a group represented by Formula (A6) or (A7), is preferable in view of transparency.

The number (n) of repetition times of the repeating unit represented by Formula (1) in a polyimide resin, which is not particularly limited, is preferably an integer of 2 or greater. Further, in view of heat resistance of the resin layer 14 and film-forming properties of a coating film, the number (n) thereof is more preferably in the range of 10 to 10,000 and still more preferably in the range of 15 to 1,000.

The molecular weight of the polyimide resin is preferably in the range of 500 to 100,000 in view of coating properties and heat resistance.

In the polyimide resin, less than 50% by mole of the total number of the residue (X) of tetracarboxylic acids may be at least one selected from the group consisting of groups exemplified below, within a range not impairing the heat resistance. Further, two or more groups exemplified below may be included.

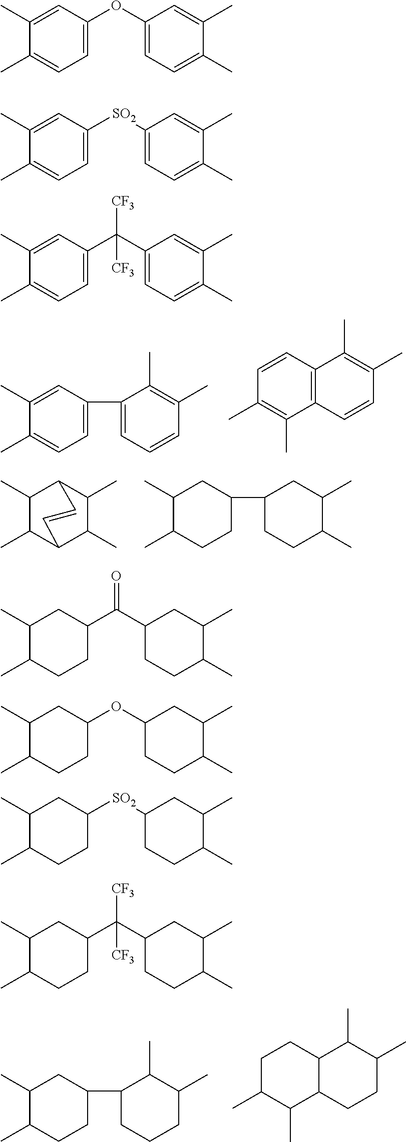

Further, in the polyimide resin, less than 50% by mole of the total number of the residue (A) of diamines may be at least one selected from the group consisting of groups exemplified below, within a range not impairing the heat resistance. Further, two or more groups exemplified below may be included.

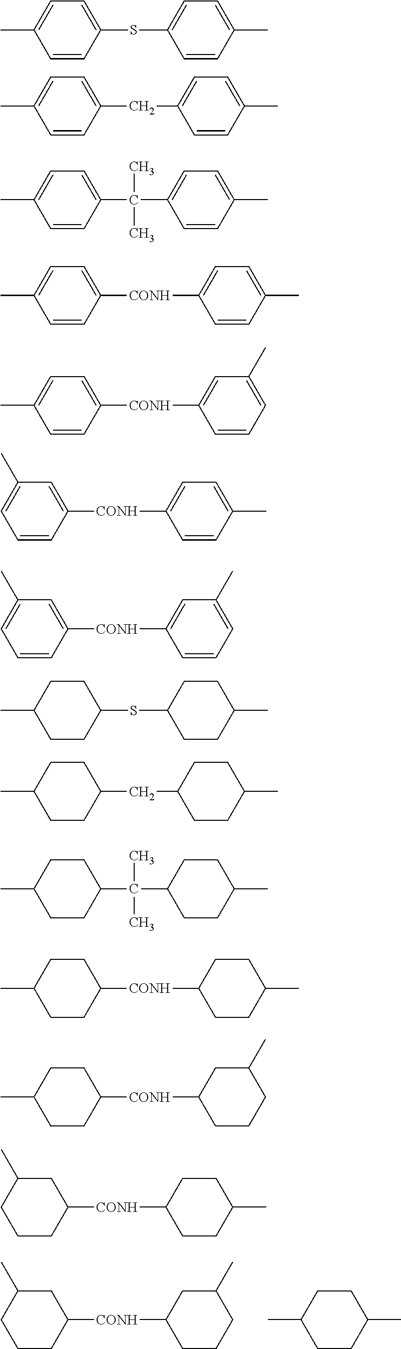

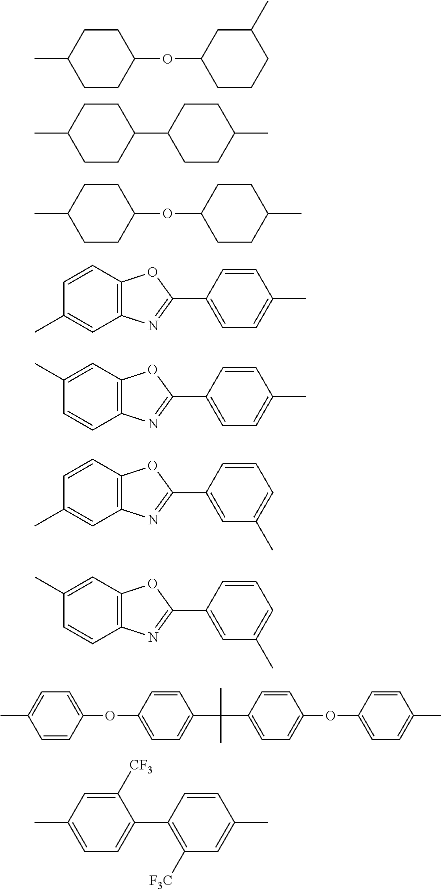

Moreover, the polyimide resin may include an alkoxysilyl group on the terminal of a molecule thereof.

As a method of introducing an alkoxysilyl group to the terminal of a molecule thereof, a method of reacting a carboxyl group or an amino group included in polyamic acid described below with epoxy group-containing alkoxysilane or a partial condensate thereof is exemplified. The epoxy group-containing alkoxysilane can be obtained by reacting an epoxy compound having a hydroxyl group in the molecule thereof with alkoxysilane or a partial condensate thereof. The number of carbon atoms of the epoxy compound having a hydroxyl group is preferably 15 or less, and glycidol or the like is exemplified. Examples of the alkoxysilane include tetraalkoxysilane having 4 or less carbon atoms and trialkoxysilane including an alkoxy group having 4 or less carbon atoms and an alkyl group having 8 or less carbon atoms. Specific examples thereof include tetraalkoxysilanes such as tetramethoxysilane, tetraethoxysilane, and tetrapropoxysilane and trialkoxysilane such as methyltrimethoxysilane. It is preferable that the epoxy compound having a hydroxyl group in the molecule thereof and the alkoxysilyl group are reacted such that the relationship of “a hydroxyl group equivalent of an epoxy compound/an alkoxysilyl group equivalent” satisfies the range of 0.001/1 to 0.5/1.

Further, an alkoxysilyl group on the terminal of a molecule of the polyimide resin may have a silica structure obtained by performing a sol-gel reaction or a dealcoholization reaction through a heat treatment or hydrolysis. At the time of the reaction, alkoxysilane may be added thereto. The above-described compound can be used as the alkoxysilane.

The heat resistance can be improved by allowing the terminal of a molecule to have a silica structure. Further, the linear expansion coefficient of the polyimide resin can be reduced and thus curvature of the resin layer-attached support substrate can be made small even when the thickness of the support substrate is small.

The content of the polyimide resin in the resin layer 14 is not particularly limited, but is preferably in the range of 50% by mass to 100% by mass, more preferably in the range of 75% by mass to 100% by mass, and still more preferably in the range of 90% by mass to 100% by mass with respect to the total mass of the resin layer from the standpoint that the peelability of the flexible substrate 18 and the support glass 12 or the heat resistance of the resin layer 14 is more excellent.

The resin layer 14 may include other components (for example, a filler or the like which does not inhibit heat resistance) other than the polyimide resin if necessary.

Examples of the filler which does not inhibit heat resistance include fibrous fillers and non-fibrous fillers such as a plate-like filler, a scale-like filler, a granular filler, an irregular filler and a crushed product. Specific examples thereof include PAN-based or pitch-based carbon fibers, glass fibers, metal fibers such as stainless steel fibers, aluminum fibers or brass fibers, gypsum fibers, ceramic fibers, asbestos fibers, zirconia fibers, alumina fibers, silica fibers, titanium oxide fibers, silicon carbide fibers, rock wool, potassium titanate whisker, barium titanate whisker, aluminum borate whisker, silicon nitride whisker, mica, talc, kaolin, silica, calcium carbonate, glass beads, glass flakes, glass microballons, clay, molybdenum disulfide, wollastonite, titanium oxide, zinc oxide, calcium polyphosphate, graphite, metal powder, metal flakes, a metal ribbon, metal oxide, carbon powder, graphite, carbon flakes, scaly carbon and a carbon nanotube. Specific examples of metals of the metal powder, the metal flake and the metal ribbon include silver, nickel, copper, zinc, aluminum, stainless steel, iron, brass, chromium and tin.

The resin layer 14 is a layer of a polyimide resin formed by subjecting a layer of a curable resin which is to be the polyimide resin formed of a repeating unit that is represented by Formula (1) and includes the residue (X) of tetracarboxylic acids and the residue (A) of diamines through thermal curing or a layer obtained by being coated with a composition containing the polyimide resin and a solvent, the layers being formed on the glass substrate, to a first heat treatment of heating in a temperature range of 60° C. or more and lower than 250° C. and a second heat treatment of heating in a temperature range of 250° C. to 500° C. in this order.

A method for producing the resin layer 14 will be described in the section of a method for producing the glass laminate below.

[Method for Producing Flexible Substrate and Glass Laminate]

In a first embodiment of the method for producing the flexible substrate 18 and the glass laminate 10 of the present invention, the resin layer 14 is formed on the glass substrate 16 using a curable resin described below, the support glass 12 is laminated on the resin layer 14, thereby producing the glass laminate 10.

When the curable resin is cured on the surface of the glass substrate 16, it is considered that the curable resin is adhered due to an interaction with the surface of the glass substrate 16 at the time of a curing reaction and the peeling strength between the resin layer 14 and the surface of the glass substrate 16 is increased. Accordingly, even when the glass substrate 16 and the support glass 12 are formed of the same material, the peeling strength between the resin layer 14 and the glass substrate 16 can be differentiated from the peeling strength between the resin layer 14 and the support glass 12.

Hereinafter, a step of forming the resin layer 14 on the glass substrate 16 using a curable resin described below is referred to as a resin layer forming step and a step of laminating the support glass 12 on the resin layer 14 to form the glass laminate 10 is referred to as a laminating step, and the procedures of respective steps will be described below.

(Resin Layer Forming Step)

The resin layer 14 is a layer of a polyimide resin formed by subjecting a layer of a curable resin which is to be the polyimide resin formed of a repeating unit that is represented by the Formula (1) and includes the residue (X) of tetracarboxylic acids and the residue (A) of diamines through thermal curing, the layer being formed on the glass substrate, to a first heat treatment of heating in a temperature range of 60° C. or more and lower than 250° C. and a second heat treatment of heating in a temperature range of 250° C. to 500° C. in this order. Moreover, 50% by mole or greater of the total number of residues (X) of tetracarboxylic acids is formed of at least one selected from the group consisting of groups represented by Formulae (X1) to (X4) and 50% by mole or greater of the total number of residues (A) of diamines is formed of at least one selected from the group consisting of groups represented by Formulae (A1) to (A7).

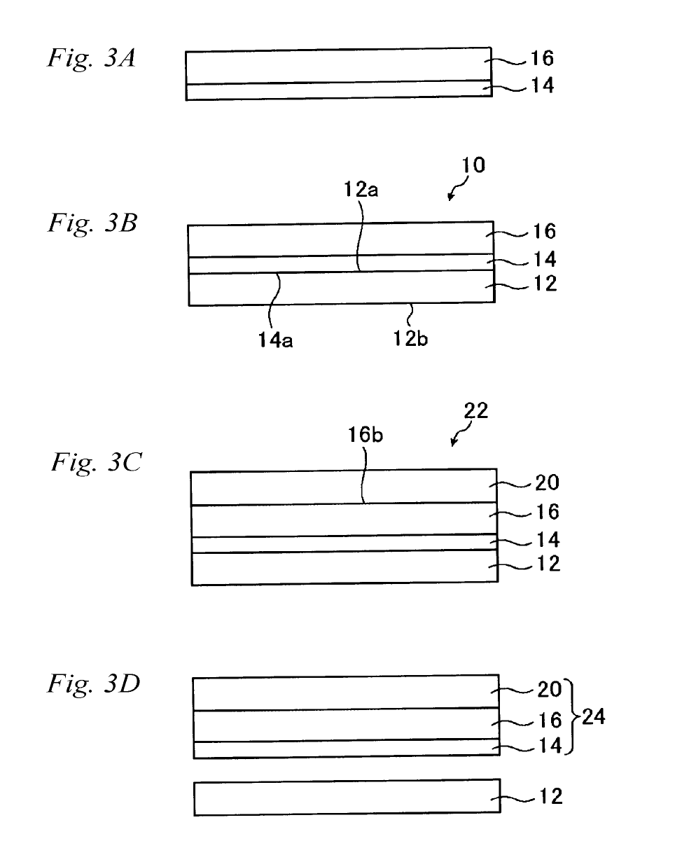

The resin layer forming step is a step of obtaining a resin layer by subjecting a layer of a curable resin which is to be the polyimide resin formed of a repeating unit that is represented by the Formula (1) and includes the residue (X) of tetracarboxylic acids and the residue (A) of diamines through thermal curing, to a first heat treatment of heating in a temperature range of 60° C. or more and lower than 250° C. and a second heat treatment of heating in a temperature range of 250° C. to 500° C. in this order. As illustrated in FIG. 3A, the resin layer 14 is formed on at least one surface of the glass substrate 16 in the step.

Hereinafter, the resin layer forming step will be described by dividing the step into three steps below.

Step (1): step of coating the glass substrate 16 with a curable resin which is to be a polyimide resin having a repeating unit represented by Formula (1) through thermal curing to obtain a coating film;

Step (2): step of heating the coating film in a temperature range of 60° C. or more and lower than 250° C.; and

Step (3): step of further heating the coating film in a temperature range of 250° C. to 500° C., thereby forming a resin layer.

Hereinafter, procedures of the respective steps will be described.

(Step (1): Coating Film Forming Step)

The step (1) is a step of coating the glass substrate 16 with a curable resin which is to be a polyimide resin having a repeating unit represented by Formula (1) through thermal curing to obtain a coating film.

In addition, it is preferable that the curable resin contains polyamic acid obtained by reacting a tetracarboxylic dianhydride with diamines, at least a part of the tetracarboxylic dianhydride is formed of at least one tetracarboxylic dianhydride selected from the group consisting of compounds represented by the following Formulae (Y1) to (Y4), and at least a part of the diamines is formed of at least one diamine selected from the group consisting of compounds represented by the following Formulae (B1) to (B7).

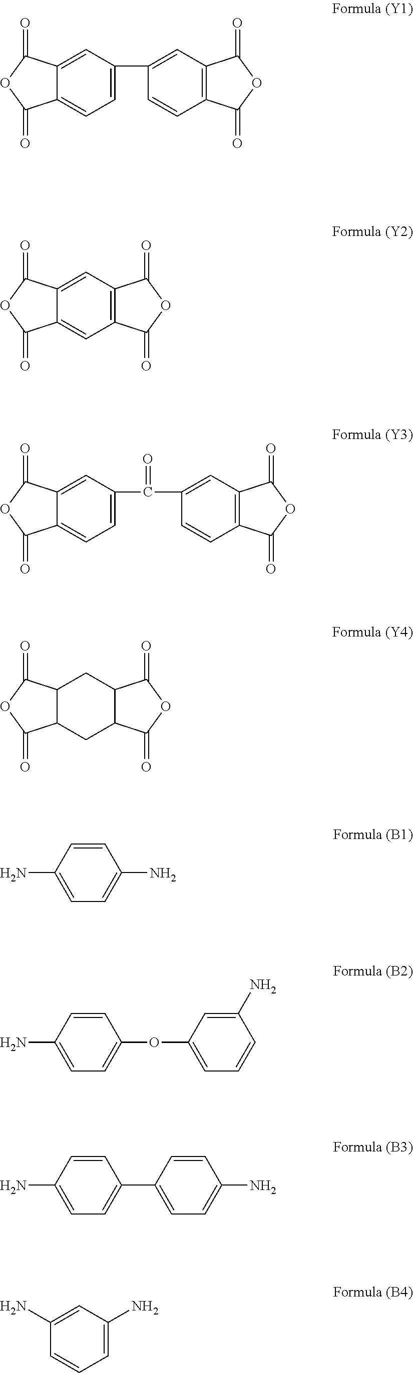

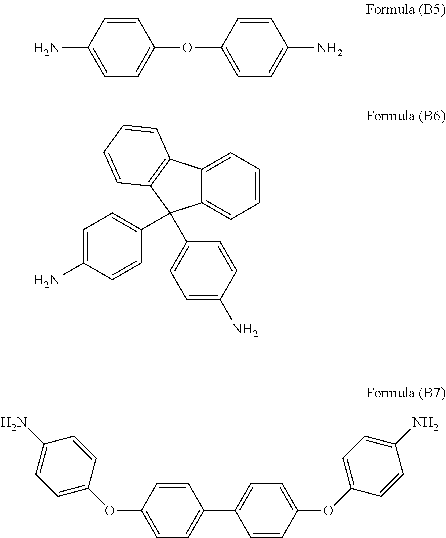 [SMILES: Nc1ccc(Oc2ccc(N)cc2)cc1 ; Nc1ccc(C2(c3ccc(N)cc3)c3ccccc3-c3ccccc32)cc1 ; Nc1ccc(Oc2ccc(-c3ccc(Oc4ccc(N)cc4)cc3)cc2)cc1]

Further, the polyamic acid is normally represented by a structural formula having a repeating unit represented by the following Formula (2-1) and/or Formula (2-2). Moreover, in Formulae (2-1) and (2-2), the definitions of X and A are as described above.

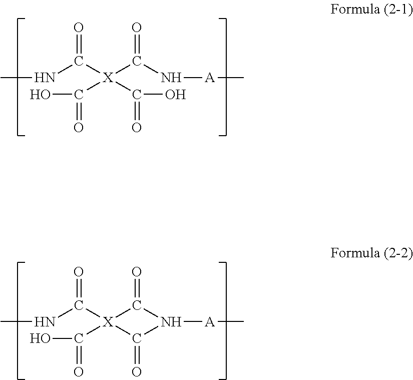

The conditions of a reaction between a tetracarboxylic dianhydride and diamines are not particularly limited, but it is preferable that the reaction is carried out in a temperature range of −30° C. to 70° C. (preferably in a temperature range of −20° C. to 40° C.) from the standpoint that polyamic acid can be efficiently synthesized.

The mixing ratio of the tetracarboxylic dianhydride to diamines is not particularly limited, but the molecular weight of the tetracarboxylic dianhydride with respect to 1 mol of diamines is preferably in the range of 0.66 mol to 1.5 mol, more preferably in the range of 0.9 mol to 1.1 mol, and still more preferably in the range of 0.97 mol to 1.03 mol.

When the tetracarboxylic dianhydride and the diamines are reacted with each other, an organic solvent may be used as needed. Examples of the kind of the organic solvent to be used, which are not particularly limited, include N-methyl-2-pyrrolidone, N,N-dimethylacetamide, N,N-diethylacetamide, N,N-dimethylformamide, N,N-diethylformamide, N-methyl caprolactam, hexamethylphosphoramide, tetramethylene sulfone, dimethyl sulfoxide, m-cresol, phenol, p-chlorophenol, 2-chloro-4-hydroxytoluene, diglyme, triglyme, tetraglyme, dioxane, γ-butyrolactone, dioxolane, cyclohexanone, and cyclopentanone and two or more kinds thereof may be used in combination.

At the time of the reaction, other tetracarboxylic dianhydrides other than the tetracarboxylic dianhydride selected from the group consisting of compounds represented by Formulae (Y1) to (Y4) may be added if necessary.

Further, at the time of the reaction, other diamines other than the diamines selected from the group consisting of compounds represented by Formulae (B1) to (B7) may be added if necessary.

As the curable resin to be used in the this step, a resin obtained by adding a tetracarboxylic dianhydride or diamines which can be reacted with polyamic acid other than the polyamic acid obtained by reacting the above-described tetracarboxylic dianhydride with diamines may be used. When a tetracarboxylic dianhydride or diamines other than polyamic acid are added, two or more polyamic acid molecules having a repeating unit represented by Formula (2-1) or (2-2) can be bonded to each other through the tetracarboxylic dianhydride or the diamines.

In a case where the terminal of the polyamic acid has an amino group, a tetracarboxylic dianhydride may be added such that the ratio of the carboxyl group is set to be in the range of 0.9 mol to 1.1 mol with respect to 1 mol of polyamic acid. In a case where the terminal of polyamic acid has a carboxyl group, diamines may be added such that the ratio of the amino group is set to be in the range of 0.9 mol to 1.1 mol with respect to 1 mol of polyamic acid. Further, in a case where the terminal of the polyamic acid has a carboxyl group, an acid terminal obtained by adding water or arbitrary alcohol to open a ring of an acid anhydride group of the terminal may be used.

It is more preferable that tetracarboxylic dianhydrides to be added later are compounds represented by Formulae (Y1) to (Y4). It is preferable that diamines to be added later are diamines having an aromatic ring and more preferable that diamines are compounds represented by Formulae (B1) to (B7).

In a case where tetracarboxylic dianhydrides or diamines are added later, the polymerization degree (n) of the polyamic acid having a repeating unit represented by Formula (2-1) or (2-2) is preferably in the range of 1 to 20. When the polymerization degree (n) is in the above-described range, the viscosity of a solution of a curable resin can be set to be low even if the concentration of the polyamic acid in the solution of the curable resin is 30% by mass or greater.

In this step, components other than a curable resin may be used.

For example, a solvent may be used. More specifically, a solution of a curable resin (curable resin solution) obtained by dissolving a curable resin in a solvent may be used. As the solvent, an organic solvent is preferable particularly in view of solubility of polyamic acid. As the organic solvent to be used, an organic solvent to be used at the time of the above-described reaction is exemplified.

In addition, as a preferable embodiment of the solvent, it is preferable to use a solvent whose boiling point (at 1 atm) is lower than 250° C. When the above-described solvent is used, the solvent is easily volatilized during the first heat treatment step and thus the appearance of a film becomes more excellent. Further, the lower limit of the boiling point, which is not particularly limited, is preferably 60° C. or greater in view of handling properties.

Moreover, in a case where a curable resin solution includes an organic solvent, the content of the organic solvent is not particularly limited as long as the thickness of a coating film can be adjusted and the coating properties are excellent. The content thereof is generally preferably in the range of 10% by mass to 99% by mass and more preferably in the range of 20% by mass to 90% by mass with respect to the total mass of the curable resin solution.

Moreover, a dehydrating agent or a dehydration ring-closing catalyst for promoting dehydration ring closure of the polyamic acid may be used together as needed. For example, as the dehydrating agent, an acid anhydride such as acetic anhydride, propionic acid anhydride or trifluoroacetic anhydride can be used. In addition, as the dehydration ring-closing catalyst, a tertiary amine such as pyridine, collidine, lutidine or triethylamine can be used.

The method of coating the surface of the glass substrate 16 with a curable resin (or a curable resin solution) is not particularly limited and a known method can be used. Examples of the method include a spray coating method, a die coating method, a spin coating method, a dip coating method, a roll coating method, a bar coating method, a screen printing method, and a gravure coating method.

The thickness of the coating film obtained by the above-described treatment is not particularly limited and is suitably adjusted such that the resin layer 14 having a desired thickness described above is obtained.

(Step (2): First Heat Treatment Step)

A step (2) is a step of heating the coating film in a temperature range of 60° C. or more and lower than 250° C. When this step is performed, a solvent can be removed while preventing bumping thereof, and thus foaming or citron skin-like film defects are unlikely to be formed.

The method of the heat treatment is not particularly limited and a known method (for example, a method of heating a coating film-attached glass substrate while allowing the glass substrate to stand still in a heating oven) is suitably used.

The heating temperature is normally in the range of 60° C. or more and lower than 250° C. In view of further suppressing foaming of a resin layer, the heating temperature is preferably in the range of 60° C. to 150° C. and more preferably in the range of 60° C. to 120° C. It is particularly preferable that the coating film is heated at a temperature lower than the boiling point of the solvent in the above-described heating temperature.

The heating time is not particularly limited and an optimum time is suitably selected based on the structure of a curable resin to be used. The heating time is preferably in the range of 5 minutes to 60 minutes and more preferably in the range of 10 minutes to 30 minutes in view of further preventing depolymerization of polyamic acid.

The atmosphere of heating is not particularly limited and, for example, the heating may be carried out in the air, in a vacuum, or in an inert gas. When the heating is carried out in a vacuum, volatile components can be removed in a shorter period of time even the coating film is heated at a low temperature and then depolymerization of polyamic acid can be further prevented, which is preferable.

Moreover, the first heat treatment step may be carried out stepwise (two or more steps) by changing the heating temperature and the heating time.

(Step (3): Second Heat Treatment Step)

A step (3) is a step of forming a resin layer by heating the coating film to which the heat treatment has been applied during the step (2), in a temperature range of 250° C. to 500° C. When this step is performed, a ring closure reaction of polyamic acid contained in a curable resin proceeds and a desired resin layer is formed.

The method of performing the heat treatment is not particularly limited and a known method (for example, a method of heating a coating film-attached glass substrate while allowing the glass substrate to stand still in a heating oven) is suitably used.

The heating temperature is normally in the range of 250° C. to 500° C. and preferably in the range of 300° C. to 450° C. from the standpoint that the residual solvent ratio is decreased, the imidization ratio is further increased, and the peelability of the flexible substrate 18 and support glass 12 or the heat resistance of the resin layer 14 is more excellent.

The heating time is not particularly limited and an optimum time is suitably selected based on the structure or the like of a curable resin to be used. The heating time is preferably in the range of 15 minutes to 120 minutes and more preferably in the range of 30 minutes to 60 minutes from the standpoint that the residual solvent ratio is decreased, the imidization ratio is further increased, and the peelability of the flexible substrate 18 and the support glass 12 or the heat resistance of the resin layer 14 is more excellent.

The atmosphere of heating is not particularly limited and, for example, the heating may be carried out in the air, in a vacuum, or in an inert gas.

A resin layer containing a polyimide resin is formed by performing the above-described step (3).

The imidization ratio of the polyimide resin is not particularly limited, but is preferably 99.0% or greater and more preferably 99.5% or greater from the standpoint that the peelability of the flexible substrate 18 and the support glass 12 or the heat resistance of the resin layer 14 is more excellent.

The imidization ratio is obtained by setting a case where a curable resin is heated in a nitrogen atmosphere at 350° C. for 2 hours as a 100% imidization ratio and calculating the intensity ratio of peak intensity of a peak derived from an imide carbonyl group (approximately 1780 cm⁻¹) to immutable peak intensity (for example, a peak derived from a benzene ring: approximately 1500 cm⁻¹) before and after the second heat treatment in the spectrum using IR of the curable resin.

(Laminating Step)

The laminating step is a step of laminating the support glass 12 on the surface of the resin layer 14 obtained in the above-described resin layer forming step to obtain the glass laminate 10 including a layer of the support glass 12, the resin layer 14, and a layer of the glass substrate 16 in this order. More specifically, as illustrated in FIG. 3B, the resin layer 14 and the support glass 12 are laminated with each other by setting the surface 14a of the resin layer 14 on the opposite side to the glass substrate 16 side and the first main surface 12a of the support glass 12 including the first main surface 12a and the second main surface 12b as lamination surfaces, thereby obtaining the glass laminate 10.

The method of laminating the support glass 12 on the resin layer 14 is not particularly limited and a known method can be employed.

For example, a method of laminating the support glass 12 on the surface of the resin layer 14 in a normal pressure environment is exemplified. Further, if necessary, the support glass 12 may be pressure-bonded to the resin layer 14 using a roll or a press after the support glass 12 is laminated on the surface of the resin layer 14. By performing pressure bonding with a roll or a press, bubbles mixed in a space between the resin layer 14 and the layer of the support glass 12 are relatively easily removed, which is preferable.

It is more preferable that the pressure bonding is performed according to a vacuum lamination method or a vacuum press method since mixture of bubbles is prevented and excellent adhesion is secured. When the pressure bonding is performed in a vacuum environment, there is an advantage that bubbles are not grown through heating and distortion defects of the support glass 12 are unlikely to occur even in a case where microbubbles remain. Further, bubbles are more unlikely to remain by performing the pressure bonding under the condition of heating in a vacuum.

When the support glass 12 is laminated, it is preferable that the surface of the support glass 12 which is to be in contact with the resin layer 14 is sufficiently washed and the support glass 12 is laminated in an environment with a high degree of cleanliness. The flatness of the support glass 12 becomes more excellent as the degree of cleanliness becomes higher, which is preferable.

In addition, a pre-annealing treatment (heat treatment) may be performed as needed after the support glass 12 is laminated. When the pre-annealing treatment is performed, the adhesiveness of the laminated support glass 12 to the resin layer 14 is improved, suitable peeling strength (y) can be obtained, and positional displacement of an electronic device member is unlikely to occur during the member forming step described below, and thus productivity of an electronic device is improved.

Optimum conditions of the pre-annealing treatment are selected according to the kind of resin layer 14 to be used, but it is preferable that the heat treatment is performed at 200° C. or higher (preferably in a temperature range of 200° C. to 400° C.) for 5 minutes or longer (preferably in the range of 5 minutes to 30 minutes) in view of obtaining more suitable peeling strength (y) between the support glass 12 and the resin layer 14.

(Glass Laminate)

The glass laminate 10 of the present invention can be used for various applications and examples thereof include applications for producing a panel for a display device described below; a photovoltaic (PV) cell; a thin-film secondary battery; and an electronic component such as a semiconductor wafer whose surface is formed with a circuit. Further, in such applications, the glass laminate 10 is frequently exposed to an environment of a high temperature (for example, 400° C. or higher) (for example, for 1 hour or longer).

Here, examples of the panel for a display device include an LCD, an OLED, electronic paper, a plasma display panel, a field emission panel, a quantum dot LED panel, and a micro electro mechanical system (MEMS) shutter panel.

Further, the embodiment of producing the resin layer-attached support substrate using a curable resin has been described above, but the flexible substrate may be produced using a layer obtained by being coated with a composition which contains the polyimide resin and a solvent (second embodiment). More specifically, the flexible substrate may be produced by forming a layer (coating film) obtained by coating the glass substrate with a composition containing the polyimide resin and a solvent and carrying out the first heat treatment of heating in a temperature range of 60° C. or more and lower than 250° C. and the second heat treatment of heating in a temperature range of 250° C. to 500° C. in this order.

The kinds of polyimide resins to be used are as described above. Further, the kind of solvent to be used is not particularly limited and a solvent contained in the above-described curable resin solution is exemplified.

Moreover, the methods of the first heat treatment and the second heat treatment are as described above.

[Member-Attached Glass Substrate and Production Method Thereof]

In the present invention, a member-attached glass substrate (electronic device member-attached glass substrate) which includes a glass substrate and an electronic device member is produced using the above-described laminate.

In view of excellent productivity of an electronic device, as the method for producing the member-attached glass substrate, which is not particularly limited, a method of forming an electronic device member on a glass substrate of the glass laminate to produce an electronic device member-attached laminate and then separating the obtained electronic device member-attached laminate into the member-attached glass substrate and the support glass using the interface on the support glass side of the resin layer as a peeling surface is preferable.

Hereinafter, the step of forming an electronic device member on the glass substrate in the glass laminate to produce an electronic device member-attached laminate is referred to as a member forming step and the step of separating the electronic device member-attached laminate into the member-attached glass substrate and the support glass using the interface on the support glass side of the resin layer as a peeling surface is referred to as a separation step.

Hereinafter, materials used in each of the steps and the procedures thereof will be described in detail.

(Member Forming Step)

The member forming step is a step of forming an electronic device member on the glass substrate 16 of the glass laminate 10 obtained by the laminating step. More specifically, as illustrated in FIG. 3C, an electronic device member 20 is formed on the second main surface 16b of the glass substrate 16, thereby obtaining an electronic device member-attached laminate 22.

First, the electronic device member 20 to be used in this step will be described in detail and then the procedures of the step will be described in detail.

(Electronic Device Member (Functional Element))

The electronic device member 20 is a member which is formed on the glass substrate 16 in the glass laminate 10 and constitutes at least a part of the electronic device. More specifically, examples of the electronic device member 20 include members used for a panel for a display device, a photovoltaic cell, a thin-film secondary battery, or an electronic component such as a semiconductor wafer whose surface is formed with a circuit (for example, a member for a display device, a member for a photovoltaic cell, a member for a thin-film secondary battery, and a circuit for an electronic component).

Examples of the member for a photovoltaic cell include silicon type members, for example, a transparent electrode such as tin oxide of a positive electrode, a silicon layer represented by a p layer/an i layer/an n layer, and a metal of a negative electrode; and other examples thereof include various members such as a compound type member, a dye-sensitized member, and a quantum dot type member.

Further, examples of the member for a thin-film secondary battery include lithium ion type members, for example, metals of a positive electrode and a negative electrode or a transparent electrode of a metal oxide and the like, a lithium compound of an electrolyte layer, a metal of a collection layer, and a resin as a sealing layer; and other examples thereof include various members such as a nickel hydrogen type member, a polymer type member, and a ceramic electrolyte type member.

Moreover, examples of the circuit for an electronic component include CCD or CMOS such as a metal of a conductive portion, and silicon oxide or silicon nitride of an insulating unit; and other examples thereof include various members, for example, various sensors such as a pressure sensor and an acceleration sensor, a rigid printed board, a flexible printed board, and a rigid flexible printed board.

(Procedures of Step)

The method for producing the electronic device member-attached laminate 22 described above is not particularly limited and the electronic device member 20 is formed on the surface of the second main surface 16b of the glass substrate 16 of the glass laminate 10 using a known method in accordance with the kind of a constituent member of the electronic device member.

Moreover, the electronic device member 20 may not be all the members (hereinafter, referred to as “all members”) to be finally formed on the second main surface 16b of the glass substrate 16, but may be some of all members (hereinafter, referred to as a “partial member”). A partial member-attached glass substrate peeled off from the support glass 12 can be used for producing an all members-attached glass substrate (corresponding to the electronic device described below) during the subsequent step.

Further, an all members-attached laminate is assembled and then an electronic device can be produced by peeling the support glass 12 from the all members-attached laminate. Moreover, two all members-attached laminates are assembled and then a member-attached glass substrate including two glass substrates can be produced as well by peeling two support glasses 12 from the all members-attached laminate.

When a case of producing an OLED is described as an example, in order to form an organic EL structure on the surface of the glass substrate 16 (corresponding to the second main surface 16b of the glass substrate 16) of the glass laminate 10 on the opposite side to the resin layer 14 side, various layer formations or various treatments such as forming a transparent electrode; performing vapor deposition of a hole injection layer, a hole transport layer, a light-emitting layer, and an electron transport layer on the surface on which the transparent electrode is formed; forming a back electrode, performing sealing using a sealing plate are carried out. Specific examples of these layer formations or treatments include a film forming treatment, a vapor deposition treatment, and a treatment of bonding a sealing plate.

In addition, a method for producing a TFT-LCD include various steps such as a TFT forming step of forming a pattern on a metal film, a metal oxide film, and the like which are formed by a normal film forming method such as a CVD method or a sputtering method on the second main surface 16b of the glass substrate 16 of the glass laminate 10 using a resist solution, thereby forming a thin film transistor (TFT); a CF forming step of forming a color filter (CF) on the second main surface 16b of the glass substrate 16 of another glass laminate 10 using the resist solution for pattern formation; and a bonding step of laminating a TFT-attached laminate obtained by the TFT forming step with a CF-attached laminate obtained by the CF forming step.

In the TFT forming step or the CF forming step, the TFT or the CF is formed on the second main surface 16b of the glass substrate 16 using a known photography technique or an etching technique. At this time, a resist solution is used as a coating solution for pattern formation.

Further, before the TFT or the CF is formed, the second main surface 16b of the glass substrate 16 may be washed if necessary. As the washing method, known dry washing or wet washing can be used.

In the bonding step, the thin film transistor-formed surface of the TFT-attached laminate is allowed to face the color filter-formed surface of the CF-attached laminate and the two surfaces are bonded to each other using a sealant (for example, a UV-curable sealant for forming a cell). Thereafter, a crystal material is injected into the cell formed by the TFT-attached laminate and the CF-attached laminate. As a method of injecting a crystal material, an injection method under reduced pressure or a dropping injection method is exemplified.

(Separation Step)

As illustrated in FIG. 3D, the separation step is a step of separating into the glass substrate 16 on which the electronic device member 20 is laminated (member-attached glass substrate) and the support glass 12 from the electronic device member-attached laminate 22 obtained by the member forming step, using the interface between the resin layer 14 and the support glass 12 as a peeling surface to obtain the member-attached glass substrate 24 which includes the electronic device member 20, the glass substrate 16, and the resin layer 14.

In a case where the electronic device member 20 on the glass substrate 16 at the time of peeling is a part of all the constituent members which are required to be formed, the remaining constituent members can be formed on the glass substrate 16 after the separation.

The method of separating into the member-attached glass substrate 24 and the support glass 12 is not particularly limited. Specifically, for example, a sharp blade-like material is inserted into the interface between the support glass 12 and the resin layer 14 to cause peeling and then the peeling can be carried out by spraying a mixed fluid of water and compressed air. Preferably, the electronic device member-attached laminate 22 is disposed on a platen such that the support glass 12 is directed upward and the electronic device member 20 is directed downward, the electronic device member is subjected to vacuum adsorption on the platen, and then the blade is allowed to infiltrate into the interface between the support glass 12 and the resin layer 14 in this state. Subsequently, the support glass 12 is adsorbed by a plurality of vacuum adsorption pads and then the vacuum adsorption pads from the vicinity of the place into which the blade is inserted are elevated in order. In this manner, an air layer is formed on the interface between the resin layer 14 and the support glass 12 and expands to the entire interface so that the support glass 12 can be easily peeled.

Moreover, the support glass 12 is laminated with a new flexible substrate 18 and thus the glass laminate 10 of the present invention can be produced.

Moreover, when the member-attached glass substrate 24 and the support glass 12 are separated, it is preferable that the peeling is carried out by spraying a peeling assistant to the interface between the support glass 12 and the resin layer 14. The peeling assistant indicates a solvent such as water described above. As the peeling assistant to be used, water, an organic solvent (such as ethanol), and a mixture thereof are exemplified.

Further, when the member-attached glass substrate 24 is separated from the an electronic device member-attached laminate 22, it is possible to prevent a fragment of the resin layer 14 from being electrostatically adsorbed to the support glass 12 by controlling the spraying or the moisture using an ionizer.

The method for producing the member-attached glass substrate 24 described above is suitable for production of a small size display device to be used in a mobile terminal such as a mobile phone or a PDA. A display device mainly indicates an LCD or an OLED. Examples of the LCD include a TN type display, an STN type display, an FE type display, a TFT type display, an MIM type display, an IPS type display, and VA type display. Basically, the production method can be applied to both of a passive drive type display device and an active drive type display device.

Examples of the member-attached glass substrate 24 produced by the above-described method include a panel for a display device including a glass substrate and a member for a display device; a photovoltaic cell including a glass substrate and a member for a photovoltaic cell; a thin-film secondary battery including a glass substrate and a member for a thin-film secondary battery; and an electronic component including a glass substrate and an electronic device member. Examples of the panel for a display device include a liquid crystal panel, an organic EL panel, a plasma display panel, and a field emission panel.

### EXAMPLES

Hereinafter, the present invention will be described in detail with reference to Examples, but the present invention is not limited thereto.

In Examples and Comparative Examples below, as a glass substrate, a glass plate formed of alkali-free borosilicate glass (length: 200 mm, width: 200 mm, plate thickness: 0.2 mm, linear expansion coefficient: 38×10⁻⁷/° C., “AN100” (trade name), manufactured by ASAHI GLASS CO., LTD.) was used. Further, as a support glass, a glass plate formed of alkali-free borosilicate glass which is the same as that described above (length: 200 mm, width: 200 mm, plate thickness: 0.5 mm, linear expansion coefficient: 38×10−7/° C., “AN100” (trade name), manufactured by ASAHI GLASS CO., LTD.) was used.

### Preparation Example 1

### Production of Polyamic Acid Solution (P1)

Paraphenylenediamine (10.8 g, 0.1 mol) was dissolved in N,N-dimethylacetamide (198.6 g) and the mixture was stirred at room temperature. (3,3′,4,4′-biphenyl tetracarboxylic dianhydride) (29.4 g, 0.1 mol) was added thereto for 1 minute and the mixture was stirred at room temperature for 2 hours, thereby obtaining a polyamic acid solution (P1) which contained polyamic acid having a repeating unit represented by Formula (2-1) and/or Formula (2-2) and whose solid content concentration was 20% by mass. When the viscosity of the solution was measured, the value was 3,000 centipoise at 20° C.

The viscosity thereof was obtained by measuring the rotational viscosity at 20° C. using a DVL-BII type digital viscometer (B type viscometer, manufactured by TOKIMEC, INC.).

Further, X in the repeating unit included in polyamic acid and represented by Formula (2-1) and/or Formula (2-2) represents a group represented by Formula (X1) and A therein represents a group represented by Formula (A1).

### Preparation Example 2

### Production of Polyamic Acid Solution (P2)

Diamino diphenyl ether (20.0 g, 0.1 mol) was dissolved in N,N-dimethylacetamide (206.8 g) and the mixture was stirred at room temperature. Pyromellitic dianhydride (21.8 g, 0.1 mol) was added thereto for 1 minute and the mixture was stirred at room temperature for 2 hours, thereby obtaining a polyamic acid solution (P2) which contained polyamic acid having a repeating unit represented by Formula (2-1) and/or Formula (2-2) and whose solid content concentration was 20% by mass. When the viscosity of the solution was measured, the value was 2,800 centipoise at 20° C.

Further, X in the repeating unit included in polyamic acid and represented by Formula (2-1) and/or Formula (2-2) represents a group represented by Formula (X2) and A therein represents a group represented by Formula (A5).

### Preparation Example 3

### Production of Alicyclic Polyimide Resin Solution (P3)

9,9-bis(4-aminophenyl)fluorene (28 g, 0.08 mol) and 4,4′-bis(4-aminophenoxy)biphenyl (7.4 g, 0.02 mol) were mixed and dissolved in γ-butyrolactone (69.3 g) and N,N-dimethylacetamide (140 g), and the mixture was stirred at room temperature. 1,2,4,5-cyclohexanetetracarboxylic dianhydride (22.5 g, 0.1 mol) was added thereto for 1 minute and the mixture was stirred at room temperature for 2 hours, thereby obtaining a polyamic acid solution (P3) whose solid content concentration was 20% by mass. When the viscosity of the solution was measured, the value was 3,300 centipoise at 20° C.

Further, X in the repeating unit included in polyamic acid and represented by Formula (2-1) and/or Formula (2-2) represents a group represented by Formula (X4) and A therein represents a group represented by Formulae (A6) and (A7).

Next, triethylamine (0.51 g, 0.005 mol) was added thereto at once as an imidization catalyst. After the dropwise addition was finished, the temperature thereof was raised to 180° C., a distillate was allowed to reflux for 5 hours while occasionally being distilled, the reaction was finished, the air was cooled until the internal temperature thereof reached 120° C., N,N-dimethylacetamide (130.7 g) was added as a dilution solvent, and the solution was cooled while being stirred, thereby obtaining an alicyclic polyimide resin solution P3 whose solid content concentration was 20% by mass.

### Preparation Example 4

### Production of Silicone Resin Composition (P4)

A mixture of 1,1,3,3-tetramethyldisiloxane (5.4 g), tetramethylcyclotetrasiloxane (96.2 g), and octamethylcyclotetrasiloxane (118.6 g) was cooled to 5° C., concentrated sulfuric acid (11.0 g) was slowly added thereto while the mixture was stirred, and water (3.3 g) was added dropwise for 1 hour. After the mixture was further stirred for 8 hours while the temperature thereof was maintained to be in the range of 10° C. to 20° C., toluene was added thereto and then the mixture was washed with water and waste acid was separated until a siloxane layer became neutral. The neutralized siloxane layer was heated and concentrated under reduced pressure and a fraction with a low boiling point such as toluene was removed, thereby obtaining organohydrogensiloxane A in which k represents an integer of 40 and 1 represents an integer of 40 in the following Formula (6).

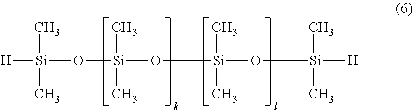

Siliconate of potassium hydroxide was added in an amount of “Si/K=20000/1 (molar ratio)” to 1.3-divinyl-1,1,3,3-tetramethyldisiloxane (3.7 g), 1,3,5,7-tetramethyl-1,3,5,7-tetravinylcyclotetrasiloxane (41.4 g), and octamethylcyclotetrasiloxane (355.9 g), the mixture was subjected to an equilibrium reaction in a nitrogen atmosphere at 150° C. for 6 hours, and then ethylene chlorohydrin was added thereto in an amount of 2 mol with respect to 1 mol of K and the mixture was neutralized at 120° C. for 2 hours. Subsequently, the mixture was heated at 160° C. and at 666 Pa for 6 hours and subjected to a bubbling treatment such that a volatile component was cut out, thereby obtaining alkenyl group-containing siloxane D whose alkenyl equivalent number La per 100 g was 0.9 and Mw was 26,000.

Organohydrogensiloxane A and an alkenyl group-containing siloxane D were mixed with each other such that the molar ratio (hydrogen atom/alkenyl group) of hydrogen atoms bonded to all silicon atoms to all alkenyl groups was set to be 0.9, 1 part by mass of a silicon compound having an acetylenically unsaturated group represented by the following Formula (8) was mixed with 100 parts by mass of the siloxane mixture, a platinum-based catalyst was added thereto such that the platinum metal concentration was set to be 100 ppm, and 5 parts by weight of heptane was added to 100 parts by mass of a resin content, thereby obtaining a solution (P4) containing crosslinkable organopolysiloxane.

HC≡C—C(CH₃)₂—O—Si(CH₃)₃ (8)

### Preparation Example 5

### Production of Polyimide Silicone Resin Solution (P5)

4,4′-hexafluoropropylidenebisphthalic dianhydride (44.4 g, 0.1 mol) and cyclohexanone (250 g) were added to a flask. Next, a solution obtained by dissolving diaminovinylsiloxane (121.8 g, 0.09 mol) represented by the following Formula (9) and 4,4′-diaminodiphenylether (2.0 g, 0.01 mol) in cyclohexanone (100 g) was added dropwise to the flask while the temperature in the reaction system was adjusted not to exceed 50° C. After the dropwise addition was finished, the solution was stirred at room temperature for 10 hours. Next, a reflux cooler provided with a moisture receptor was attached to the flask, xylene (70 g) was added thereto, and the temperature was raised to 150° C. and then maintained for 6 hours, thereby obtaining a yellowish brown solution. After the solution obtained in this manner was cooled to room temperature (25° C.) and then poured into methanol, obtained precipitate was dried and then a polyimide silicone resin formed of repeating units represented by the following Formulae (10-1) and (10-2) was obtained. The obtained polyimide silicone resin was diluted in propylene glycol 1-monomethyl ether 2-acetate, thereby obtaining a polyimide silicone resin solution (P5) whose solid content concentration was 20% by mass.

When the viscosity of the solution was measured, the value was 1,500 centipoise at 20° C.

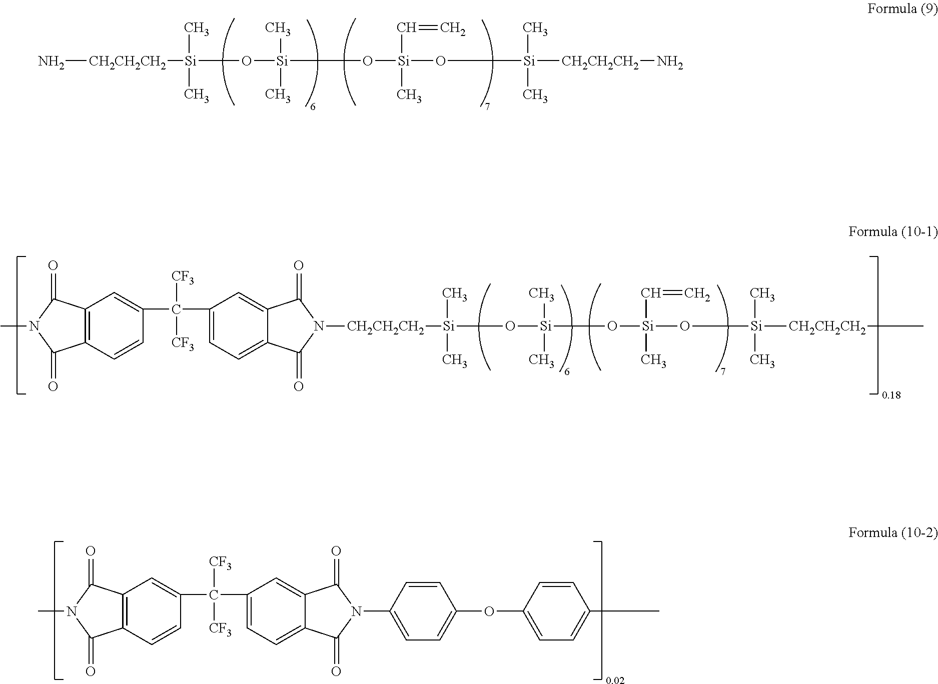

### Example 1

First, a glass substrate having a plate thickness of 0.2 mm was washed with pure water and then cleaned by UV washing.

Next, the polyamic acid solution (P1) was applied to a first main surface of the glass substrate using a spin coater (rotation speed: 1,000 rpm, 15 seconds) and a coating film containing polyamic acid was provided on the glass substrate (coating weight: 2 g/m²).

Incidentally, the polyamic acid is a resin obtained by reacting a compound represented by Formula (Y1) with a compound represented by Formula (B1).

Subsequently, a resin layer (thickness: 25 μm) was formed by heating the coating film at 60° C. for 15 minutes and 120° C. for 15 minutes in air and then further heating the coating film at 350° C. for 15 minutes. The formed resin layer contained a polyimide resin having a repeating unit represented by the following formula (in which X in Formula (1) is a group represented by (X1) and A is a group represented by (A1))

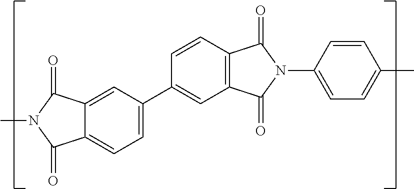

Further, the imidization ratio was 99.7%. In addition, the surface roughness Ra of the surface of the formed resin layer was 0.2 nm.

Further, the method of measuring the imidization ratio and the method of measuring the surface roughness Ra were carried out in the above-described manners.

Subsequently, the support glass and the resin layer in the flexible substrate were bonded to each other through vacuum press at room temperature, thereby obtaining a glass laminate S1.

In the obtained glass laminate S1, the support glass and the glass substrate were tightly bonded to the resin layer without generating bubbles, distortion defects were not found, and the smoothness was excellent. Moreover, in the glass laminate S1, the peeling strength (X) of the interface between the layer of the glass substrate and the resin layer was greater than the peeling strength (y) of the interface between the resin layer and the support glass.

Next, when the glass laminate S1 was subjected to a heat treatment in air at 400° C. for 60 minutes and then was allowed to be cooled to room temperature, separation of the flexible substrate and the support glass of the glass laminate S1, or changes in appearance such as foaming and whitening of the resin layer were not recognized.

Moreover, a stainless steel blade having a thickness of 0.1 mm was inserted into the interface between the support glass and the resin layer in one corner portion from among four corner portions of the glass laminate S1 and a peeled cutout portion was formed, a vacuum adsorption pads were adsorbed on surfaces which were not peeling surfaces of the glass substrate and the support glass respectively, external force was applied to a direction of separation of the glass substrate and the support glass while water was sprayed to the interface between the support glass and the resin layer, and then the flexible substrate and the support glass were separated without being destroyed. Here, the insertion of the blade was carried out by spraying a discharge fluid to the interface thereof from an ionizer (manufactured by KEYENCE CORPORATION).

In addition, the resin layer and the glass substrate were separated from the support glass. As shown from the results described above, it was confirmed that the peeing strength (x) of the interface between the glass substrate and the resin layer was greater than the peeling strength (y) of the interface between the resin layer and the support glass.

### Example 2

A glass laminate S2 was obtained in the same manner as in Example 1 except that the polyamic acid solution (P2) was used instead of the polyamic acid solution (P1).

Incidentally, the polyamic acid is a resin obtained by reacting a compound represented by Formula (Y2) and a compound represented by Formula (B5). The formed resin layer contained a polyimide resin having a repeating unit represented by the following formula (in which X in Formula (1) is a group represented by Formula (X2) and A is a group represented by Formula (A5)).

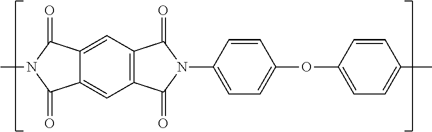

Further, the imidization ratio was 99.5%. In addition, the surface roughness Ra of the surface of the formed resin layer was 0.2 nm.

In the obtained glass laminate S2, the support glass and the glass substrate were tightly bonded to the resin layer without generating bubbles, distortion defects were not found, and the smoothness was excellent.

Next, when the glass laminate S2 was subjected to the same heat treatment as in Example 1, separation of the support glass and the flexible substrate of the glass laminate S2, or changes in appearance such as foaming and whitening of the resin layer were not recognized.

Further, in the glass laminate S2, when separation of the support glass and the flexible substrate were carried out in the same manner as in Example 1, the support glass and the flexible substrate were separated without being destroyed. In addition, the resin layer and the glass substrate were separated from the support glass.

Further, it was confirmed that the peeling strength (x) of the interface between the glass substrate and the resin layer was greater than the peeling strength (y) of the interface between the resin layer and the support glass.

### Example 3

A glass laminate S3 was obtained in the same manner as in Example 1 except that the alicyclic polyimide resin solution (P3) was used instead of the polyamic acid solution (P1).

Incidentally, the polyimide is a resin obtained by reacting a compound represented by Formula (Y4) and compounds represented by Formulae (B6) and (B7). The formed resin layer contained a polyimide resin formed of a group in which X in Formula (1) was represented by Formula (X4) and A was represented by Formulae (A6) and (A7). The content ratio of respective residues represented by (X4), (A6), and (A7) was 1:0.8:0.2 in terms of the molar ratio.

Further, the imidization ratio was 99.7%. In addition, the surface roughness Ra of the surface of the formed resin layer was 0.2 nm.

In the obtained glass laminate S3, the support glass and the glass substrate were tightly bonded to the resin layer without generating bubbles, distortion defects were not found, and the smoothness was excellent.

Next, when the glass laminate S3 was subjected to the same heat treatment as in Example 1, separation of the support glass and the flexible substrate of the glass laminate S3, or changes in appearance such as foaming and whitening of the resin layer were not recognized.

Further, in the glass laminate S3, when separation of the support glass and the flexible substrate were carried out in the same manner as in Example 1, the support glass and the flexible substrate were separated without being destroyed. In addition, the resin layer and the glass substrate were separated from the support glass.

### Comparative Example 1

A glass laminate C1 was obtained in the same manner as in Example 1 except that the silicone resin solution (P4) was used instead of the polyamic acid solution (P1). In addition, the present embodiment corresponds to the embodiment of using a silicone resin layer as the resin layer described in Patent Document 1.

In the obtained glass laminate C1, when separation of the support glass and the flexible substrate were carried out in the same manner as in Example 1, the silicone resin layer and the support glass were unlikely to be peeled and the flexible substrate was cracked.

In addition, after the glass laminate C1 was subjected to the heat treatment in air at 400° C. for 60 minutes, foaming and whitening of the silicone resin layer was found.

### Comparative Example 2

A glass laminate C2 was obtained in the same manner as in Example 1 except that the polyimide silicone solution (P5) was used instead of the polyamic acid solution (P1). In addition, the present embodiment corresponds to the embodiment of using a resin layer containing polyimide silicone as the resin layer described in WO2012/053548 (hereinafter, also referred to as Patent Document 2).

In the obtained glass laminate C2, when separation of the support glass and the flexible substrate were carried out in the same manner as in Example 1, the silicone resin layer and the support glass were unlikely to be peeled and the flexible substrate was cracked.

In addition, after the glass laminate C2 was subjected to the heat treatment in air at 400° C. for 60 minutes, foaming and whitening of the resin layer was found.

### Comparative Example 3

Production of a flexible substrate was attempted by bonding a polyimide film (kapton H, manufactured by TORAY INDUSTRIES, INC., thickness: 12.5 μm) to a glass substrate having a thickness of 0.2 mm using an air laminator (Sankyo laminating machine), but the polyimide film was not adhered to the glass substrate due to unevenness.

In addition, the surface roughness Ra of the surface of the resin layer was 10 nm.

Further, the support glass, the polyimide film, and the glass substrate were laminated with each other in this order and bonded to each other using a roll lamination device (“HAL-TEC” manufactured by Sankyo Corporation) described below at room temperature, but the support glass, the polyimide film, and the glass substrate were not adhered to each other.

### Comparative Example 4

A glass substrate provided with a coating film containing polyamic acid was prepared by coating the glass substrate with the polyamic acid solution (P1) in the same manner as in Example 1.

Next, a resin layer was formed by heating the coating film at 60° C. for 15 minutes and 120° C. for 15 minutes in air. At this time, the second heat treatment under the condition of heating the coating film at a temperature of 250° C. or greater was not carried out. The formed resin layer contained a polyimide resin having a repeating unit represented by the following formula (in which X in Formula (1) is a group represented by (X1) and A is a group represented by (A1)).

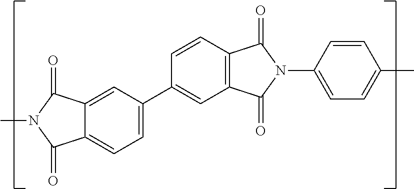

Further, the surface roughness Ra of the surface of the formed resin layer was 0.2 nm. Since the resin layer prepared by the above-described heat treatment was not sufficiently imidized and the amount of residual solvent was large, the entire surface was foamed by a heating test (heating at 400° C. for 60 minutes) performed after lamination of the support glass, and a peeling test was unable to be carried out.

### Comparative Example 5

A glass substrate provided with a coating film containing polyamic acid was prepared by coating the glass substrate with the polyamic acid solution (P1) in the same manner as in Example 1.

Next, a resin layer was formed by heating the coating film at 350° C. for 15 minutes in air. At this time, the first heat treatment under the condition of heating the coating film at a temperature which was lower than 250° C. was not carried out. The formed resin layer contained a polyimide resin having a repeating unit represented by the following formula (in which X in Formula (1) is a group represented by (X1) and A is a group represented by (A1)).

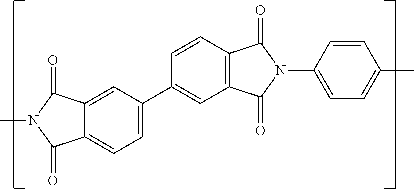

In the resin layer prepared by the above-described heat treatment, since the solvent was bumped on the surface of the resin layer and surface unevenness was generated, lamination of the support glass was not possible.

<Adhesiveness Evaluation>

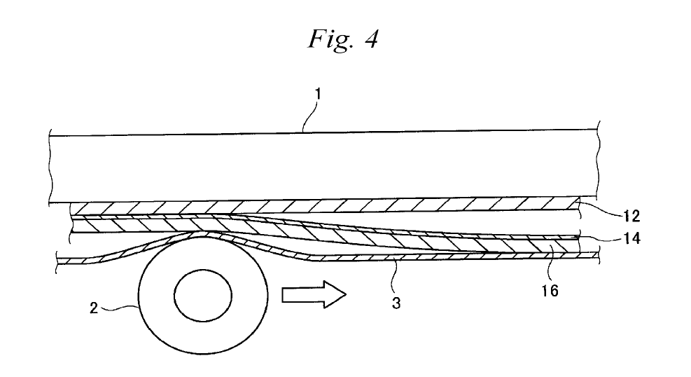

The flexible substrate and the support glass were stacked with each other and were roll-laminated with each other in air so as to have a push-in amount of 1 mm using “HAL-TEC” manufactured by Sankyo Corporation. HAL-TEC is a roll lamination device illustrated in FIG. 4. As illustrated in FIG. 4, the support glass 12 was fixed to an upper platen 1 and the flexible substrate and the support glass 12 were bonded to each other while a rubber roll 2 was pressed (pressing force: 0.3 MPa) to the flexible substrate including the resin layer 14 and the glass substrate 16 through a resin mesh 3. Further, the above-described method was carried out in Comparative Example 3.

A case where the flexible substrate was bonded to the support glass was evaluated as “O” and a case where the flexible substrate was not bonded to the support glass was evaluated as “X.”

The results of Examples 1 to 3 and Comparative Examples 1 to 5 are collectively listed in Table 1.

Moreover, in Table 1, the columns of “Presence or absence of first heat treatment step” show the presence or absence of the step of heating the coating film in a temperature range of 60° C. or more and lower than 250° C. A case where the step was performed was evaluated as “O” and a case where the step was not performed was evaluated as “X.” Further, in Table 1, the columns of “Presence or absence of second heat treatment step” show the presence or absence of the step of heating the coating film in a temperature range of 250° C. to 500° C. A case where the step was performed was evaluated as “O” and a case where the step was not performed was evaluated as “X.” Further, in Table 1, since the heat treatments of Comparative Examples 1 and 2 were respectively carried out by the methods described in Patent Documents 1 and 2, “-” is written in the columns of “Presence or absence of first heat treatment step” and the columns of “Presence or absence of second heat treatment step”

Further, in the column of “Appearance” in Table 1, a case where foaming and whitening of the resin layer were not observed was evaluated as “O” and a case where foaming and whitening of the resin layer were observed was evaluated as “X.”

In addition, in the columns of “Peelability” in Table 1, a case where the glass substrate was not cracked at the time of peeling of the flexible substrate was evaluated as “O” and a case where the glass substrate was cracked was evaluated as “X.”

TABLE 1

| | | Presence or | Presence or | Surface | | | |
|---|---|---|---|---|---|---|---|
| | | absence of | absence of | roughness Ra | | | |
| | | first heat | second heat | of resin layer | | | |
| | Component in resin layer | treatment step | treatment step | (nm) | Appearance | Peelability | Adhesiveness |
| Example 1 | Polyimide including a group represented | ◯ | ◯ | 0.2 | ◯ | ◯ | ◯ |
| | by Formula (X1) and a group represented | | | | | | |
| | by Formula (A1) | | | | | | |
| Example 2 | Polyimide including a group represented | ◯ | ◯ | 0.2 | ◯ | ◯ | ◯ |
| | by Formula (X2) and a group represented | | | | | | |
| | by Formula (A5) | | | | | | |
| Example 3 | Polyimide including a group represented | ◯ | ◯ | 0.2 | ◯ | ◯ | ◯ |
| | by Formula (X4) and groups represented | | | | | | |
| | by Formulae (A6) and (A7) | | | | | | |
| Comparative | Silicone | — | — | 0.1 | X | X | ◯ |
| Example 1 | | | | | | | |
| Comparative | Polyimide silicone | — | — | 0.2 | X | X | ◯ |
| Example 2 | | | | | | | |
| Comparative | Kaptone film | — | — | 10 | — | — | X |
| Example 3 | | | | | | | |
| Comparative | Polyimide including a group represented | ◯ | X | 0.2 | X | — | — |
| Example 4 | by Formula (X1) and a group represented | | | | | | |
| | by Formula (A1) | | | | | | |
| Comparative | Polyimide including a group represented | X | ◯ | Greater than | X (impossible to | — | — |
| Example 5 | by Formula (X1) and a group represented | | | 2.0 | laminate) | | |
| | by Formula (A1) | | | | | | |

As listed in Table 1, in Examples 1 to 3 for which predetermined resin layers were used, the resin layers were not decomposed even after the heat treatment was carried out at 400° C. for 1 hour and peeling of the flexible substrate easily proceeded. Further, the adhesiveness of the flexible substrate to the support glass was excellent.

Further, in Example 3, transparency of the resin layer was excellent.

Meanwhile, in Comparative Example 1 for which the silicone resin layer described in Patent Document 1 was used and Comparative Example 2 for which the resin layer described in patent Document 2 was used, desired effects were not obtained.

In Comparative Example 3, the lamination was not possible due to surface unevenness.

Further, in Comparative Example 4 in which the second heat treatment was not carried out at a predetermined temperature and Comparative Example 5 in which the first heat treatment was not carried out, desired effects were not obtained.

Moreover, in a case of the resin layers used in Examples 1 and 2, when the heating temperature was changed from 400° C. to 450° C., foaming and whitening were not found in the resin layers and peeling of the flexible substrate easily proceeded.

Further, when the heating temperature was changed from 450° C. to 500° C., desired effects were not obtained in Example 2. However, in a case of the resin layer used in Example 1, foaming and whitening were not found in the resin layer and peeling of the flexible substrate easily proceeded.

From the results described above, it was confirmed that the embodiment of Example 1 was most excellent among the embodiments of Examples 1 to 3.

### Example 4

In the present example, an OLED is produced using the glass laminate S1 obtained in Example 1.

First, film formation is carried out in order of silicon nitride, silicon oxide, and amorphous silicon on the second main surface of the glass substrate in the glass laminate S1 according to a plasma CVD method. Next, boron with low concentration is injected to the amorphos silicon layer using an ion doping device and the layer is subjected to a heat treatment and a dehydrogenation treatment in a nitrogen atmosphere. Next, the amorphous silicon layer is subjected to a crystallization treatment using a laser annealing device. Next, phosphorus with low concentration is injected to the amorphous silicon layer by etching using a photolithography method and the ion doping device and N type and P type TFT areas are formed. Subsequently, a silicon oxide film is formed using the plasma CVD method to form a gate insulating film on the second main surface side of the glass substrate, film formation is carried out with molybdenum using a sputtering method, and then a gate electrode is formed by etching using the photolithography method. Subsequently, boron and phosphorus with high concentration are respectively injected to the N type and the P type of desired areas using the photolithography method and the ion doping device and a source area and a drain area are formed. Next, an interlayer insulating film is formed on the second main surface side of the glass substrate through film formation of silicon oxide using the plasma CVD method and a TFT electrode is formed on the second main surface side of the glass substrate through film formation with aluminum using the sputtering method and etching using the photolithography method. Next, after a heat treatment and a hydrogenation treatment are carried out in a hydrogen atmosphere, a passivation layer is formed through film formation with silicon nitride using the plasma CVD method. Subsequently, the second main surface side of the glass substrate is coated with a UV-curable resin and then a planarizing layer and a contact hole are formed using the photolithography method. Next, film formation is carried out with indium tin oxide using the sputtering method and then a pixel electrode is formed by etching using the photolithography method.

Next, on the second main surface side of the glass substrate, 4,4′,4″-tris(3-methylphenylphenylamino)triphenylamine is formed as a positive hole injection layer, bis[(N-naphthyl)-N-phenyl]benzidine is formed as a positive hold transport layer, a mixture made by adding 40% by volume of 2,6-bis[4-[N-(4-methoxyphenyl)-N-phenyl]aminostyryl]naphthalene-1,5-dicarbonitrile (BSN—BCN) to a 8-quinolinol aluminum complex (Alq₃) is formed as a light-emitting layer, and Alg₃ is formed as an electron transport layer in this order using an evaporation method. Subsequently, film formation is carried out with aluminum using the sputtering method and a counter electrode is formed by etching using the photolithography method. Next, another glass substrate is bonded to the second main surface of the glass substrate through a UV-curable adhesive layer to be sealed. By following the above-described procedures, an organic EL structure is formed on the glass substrate. A glass laminate S1 (hereinafter, referred to as a panel A) having the organic EL structure on the glass substrate is the electronic device member-attached laminate of the invention.

Next, a sealing body of the panel A is vacuum-adsorbed on the platen and a stainless steel blade having a thickness of 0.1 mm is inserted into the interface between the support glass and the resin layer of a corner portion of the panel A to cause peeling for the interface between the support glass and the resin layer. In addition, the surface of the support glass of the panel A is adsorbed by vacuum adsorption pads and then the adsorption pads are elevated. Here, the insertion of the blade is carried out by spraying a discharge fluid to the interface thereof from an ionizer (manufactured by KEYENCE CORPORATION). Next, the vacuum adsorption pads are pulled up while the discharge fluid is continuously sprayed toward a formed space from the ionizer and water is poured to the peeling front line. As a result, peeling of the support glass is possible while only the flexible substrate formed with an organic EL structure remains on the platen.

Next, the peeled surface of the separated resin layer is cleaned in the same manner as in Example 1, the separated glass substrate is cut and divided into a plurality of cells using a laser cutter or a scribing and breaking method, the glass substrate on which an organic EL structure is formed and the counter substrate are assembled with each other, and a module forming step is carried out, thereby preparing an OLED. The OLED obtained in the above-described manner does not have any problems with the characteristics.

### Example 5

In the present example, an OLED is produced using the glass laminate S1 obtained in Example 1.

First, film formation is carried out with molybdenum on the second main surface of the glass substrate in the glass laminate S1 using a sputtering method and then a gate electrode is formed thereon by etching using the photolithography method. Subsequently, film formation is further carried out with aluminum oxide on the second main surface of the glass substrate using the sputtering method and a gate insulting film is formed thereon and film formation is carried out with indium gallium zinc oxide using the sputtering method, thereby forming an oxide semiconductor layer by etching using the photolithography method. Subsequently, a channel protection layer is formed by further carrying out film formation with aluminum oxide on the second main surface of the glass substrate using the sputtering method, and a source electrode and a drain electrode are formed by carrying out film formation with molybdenum using the sputtering method and performing etching using the photolithography method.

Next, the heat treatment is carried out in an air atmosphere. Then, a passivation layer is formed on the second main surface of the glass substrate by further carrying out film formation with aluminum oxide using the sputtering method, and a pixel electrode is formed by carrying out film formation with indium tin oxide using the sputtering method and performing etching using the photolithography method.

Next, on the second main surface of the glass substrate, 4,4′,4″-tris(3-methylphenylphenylamino)triphenylamine is formed as a positive hole injection layer, bis[(N-naphthyl)-N-phenyl]benzidine is formed as a positive hole transport layer, a mixture made by adding 40% by volume of 2,6-bis[4-[N-(4-methoxyphenyl)-N-phenyl]aminostyryl]naphthalene-1,5-dicarbonitrile (BSN—BCN) to a 8-quinolinol aluminum complex (Alq₃) is formed as a light-emitting layer, and Alg₃ is formed as an electron transport layer in this order using an evaporation method. Subsequently, film formation is carried out with aluminum using the sputtering method and a counter electrode is formed by etching using the photolithography method. Next, one more glass substrate is bonded to the second main surface of the glass substrate through a UV-curable adhesive layer to be sealed. By following the above-described procedures, an organic EL structure is formed on the glass substrate. A glass laminate S1 (hereinafter, referred to as a panel B) having the organic EL structure on the glass substrate is the electronic device member-attached laminate of the present invention.

Next, a sealing body of the panel B is vacuum-adsorbed on the platen and a stainless steel blade having a thickness of 0.1 mm is inserted into the interface between the support glass and the resin layer of a corner portion of the panel B to cause peeling for the interface between the support glass and the resin layer. In addition, the surface of the support glass of the panel B is adsorbed by vacuum adsorption pads and then the adsorption pads are elevated. Here, the insertion of the blade is carried out by spraying a discharge fluid to the interface thereof from an ionizer (manufactured by KEYENCE CORPORATION). Next, the vacuum adsorption pads are pulled up while the discharge fluid is continuously sprayed toward a formed space from the ionizer and water is poured to the peeling front line. As a result, peeling of the support glass is possible while only the flexible substrate formed with an organic EL structure remains on the platen.

Next, the peeled surface of the resin layer is cleaned, the separated glass substrate is cut and divided into a plurality of cells using a laser cutter or a scribing and breaking method, the glass substrate on which an organic EL structure is formed and the counter substrate are assembled with each other, and a module forming step is carried out, thereby preparing an OLED. The OLED obtained in the above-described manner does not have any problems with the characteristics.

The present application is based on Japanese Patent Application No. 2013-112319 filed on May 28, 2013 and Japanese Patent Application No. 2014-034438 filed on Feb. 25, 2014, the contents of which are incorporated herein by reference.

### DESCRIPTION OF REFERENCE NUMERALS AND SIGNS

1: Upper platen
2: Rubber roll
3: Resin mesh
10: Glass laminate
12: Support glass
14: Resin layer
16: Glass substrate
18: Flexible substrate
20: Electronic device member
22: Electronic device member-attached laminate
24: Member-attached glass substrate

1. A flexible substrate comprising:
a glass substrate; and
a layer of a polyimide resin which is formed on the glass substrate,
wherein the flexible substrate is used for producing a glass laminate by laminating a support glass on the layer of the polyimide resin,
the polyimide resin in the flexible substrate is a polyimide resin which is formed of a repeating unit that is represented by the following Formula (1) and includes residues (X) of tetracarboxylic acids and residues (A) of diamines and in which 50% by mole or greater of a total number of the residues (X) of tetracarboxylic acids is formed of at least one group selected from the group consisting of groups represented by the following Formulae (X1) to (X4) and 50% by mole or greater of a total number of the residues (A) of diamines is formed of at least one group selected from the group consisting of groups represented by the following Formulae (A1) to (A7), and
the layer of the polyimide resin on the glass substrate is a layer of a polyimide resin formed by subjecting a layer (I) of a curable resin which is to be the polyimide resin through thermal curing or a layer (II) obtained by being coated with a composition containing the polyimide resin and a solvent, the layers (I) and (II) being formed on the glass substrate, to a first heat treatment of heating in a temperature range of 60° C. or more and lower than 250° C. and a second heat treatment of heating in a temperature range of 250° C. to 500° C. in this order: 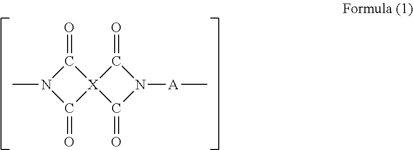
in Formula (1), X represents a tetracarboxylic acid residue obtained by removing a carboxy group from tetracarboxylic acids and A represents a diamine residue obtained by removing an amino group from diamines;

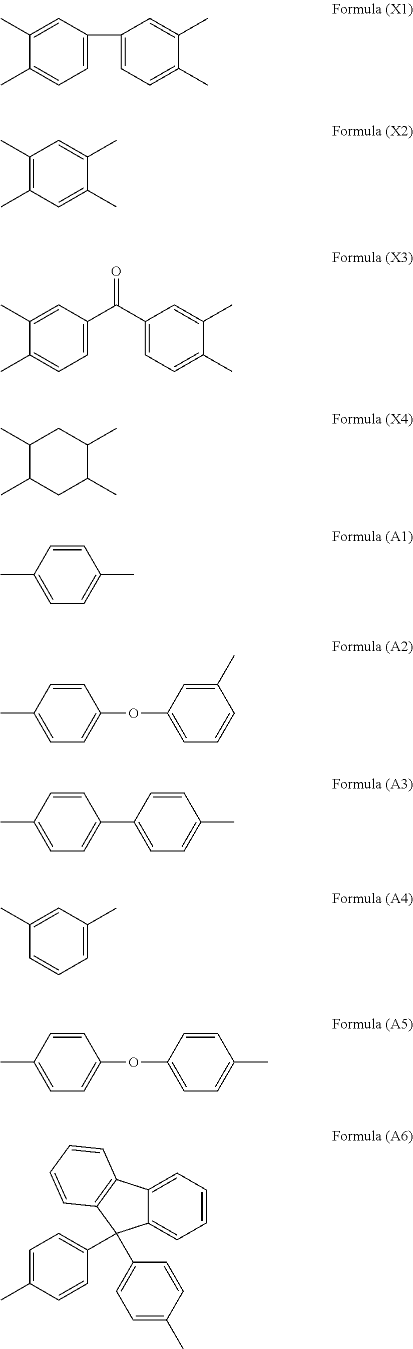

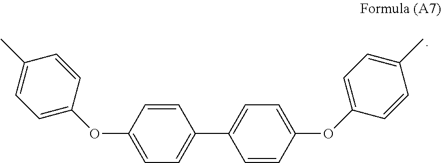

2. The flexible substrate according to claim 1,
wherein, in the polyimide resin, 80% by mole to 100% by mole of the total number of the residues (X) of tetracarboxylic acids is formed of at least one group selected from the group consisting of groups represented by the Formulae (X1) to (X4), and
80% by mole to 100% by mole of the total number of the residues (A) of diamines is formed of at least one group selected from the group consisting of groups represented by the Formulae (A1) to (A7).

3. The flexible substrate according to claim 1, wherein the layer of the polyimide resin has a thickness in a range of 0.1 μm to 100 μm.

4. The flexible substrate according to claim 1, wherein a surface roughness Ra of an exposed surface of the layer of the polyimide resin is in a range of 0 nm to 2.0 nm.

5. A glass laminate comprising:
the flexible substrate according to claim 1; and
a support glass which is laminated on a surface of the layer of the polyimide resin of the flexible substrate.

6. A method for producing a flexible substrate, comprising:
forming a layer of a curable resin which is to be the following polyimide resin through thermal curing on a glass substrate, and subjecting the layer to a first heat treatment of heating in a temperature range of 60° C. or more and lower than 250° C. and a second heat treatment of heating in a temperature range of 250° C. to 500° C. in this order to convert the curable resin into the following polyimide resin, thereby forming a layer of the polyimide resin:
the polyamide resin: a polyimide resin which is formed of a repeating unit that is represented by the following Formula (1) and includes residues (X) of tetracarboxylic acids and residues (A) of diamines and in which 50% by mole or greater of a total number of the residues (X) of tetracarboxylic acids is formed of at least one group selected from the group consisting of groups represented by the following Formulae (X1) to (X4) and 50% by mole or greater of a total number of the residues (A) of diamines is formed of at least one group selected from the group consisting of groups represented by the following Formulae (A1) to (A7): 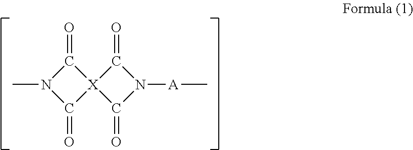
in Formula (1), X represents a tetracarboxylic acid residue obtained by removing a carboxy group from tetracarboxylic acids and A represents a diamine residue obtained by removing an amino group from diamines;

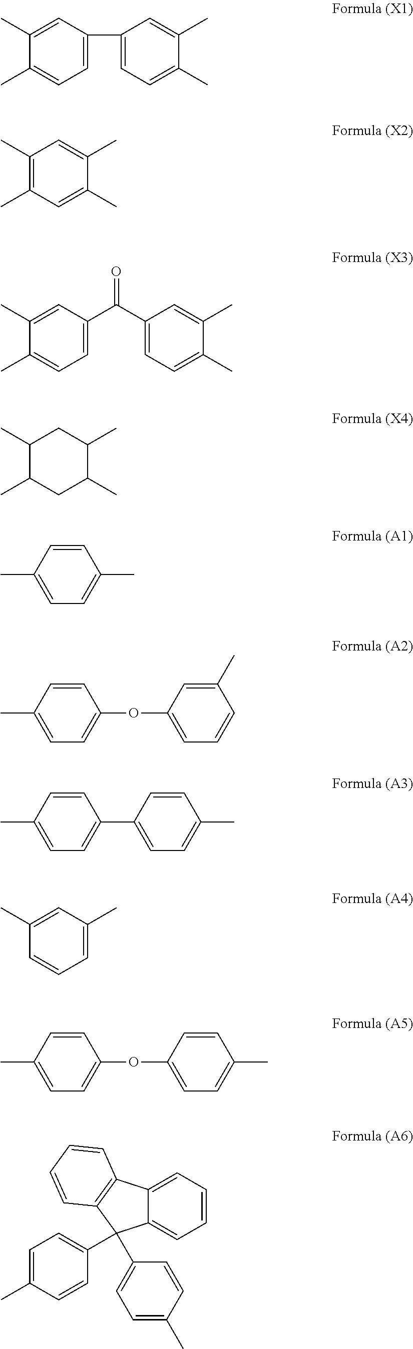

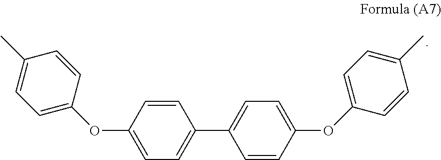

7. The method for producing a flexible substrate according to claim 6,
wherein, in the polyimide resin, 80% by mole to 100% by mole of the total number of the residues (X) of tetracarboxylic acids is formed of at least one group selected from the group consisting of groups represented by the Formulae (X1) to (X4), and
80% by mole to 100% by mole of the total number of the residues (A) of diamines is formed of at least one group selected from the group consisting of groups represented by the Formulae (A1) to (A7).

8. The method for producing a flexible substrate according to claim 6, wherein the layer of the polyimide resin has a thickness in a range of 0.1 μm to 100 μm.

9. The method for producing a flexible substrate according to claim 6, wherein the layer of the curable resin is formed by coating a solution of the curable resin on the glass substrate to form a coating film of the solution, and then removing a solvent from the coating film during the first heat treatment.

10. The method for producing a flexible substrate according to claim 6,
wherein the curable resin contains polyamic acid obtained by reacting a tetracarboxylic dianhydride with diamines,
at least a part of the tetracarboxylic dianhydride is formed of at least one tetracarboxylic dianhydride selected from the group consisting of compounds represented by the following Formulae (Y1) to (Y4), and
at least a part of the diamines is formed of at least one diamine selected from the group consisting of compounds represented by the following Formulae (B1) to (B7):

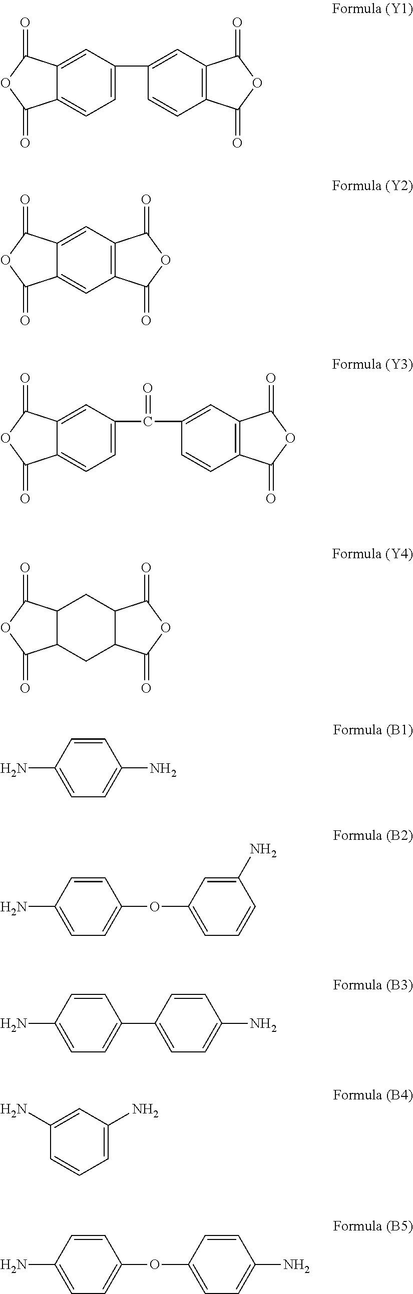

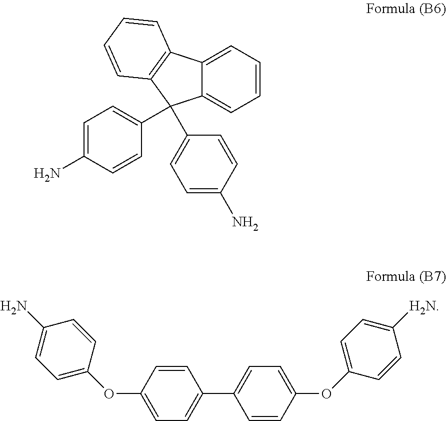 [SMILES: Nc1ccc(C2(c3ccc(N)cc3)c3ccccc3-c3ccccc32)cc1 ; Nc1ccc(Oc2ccc(-c3ccc(Oc4ccc(N)cc4)cc3)cc2)cc1]

11. A method for producing a flexible substrate, comprising:
forming a layer obtained by coating a composition containing the following polyimide resin and a solvent on a glass substrate, and subjecting the layer to a first heat treatment of heating in a temperature range of 60° C. or more and lower than 250° C. and a second heat treatment of heating in a temperature range of 250° C. to 500° C. in this order, thereby producing a flexible substrate which comprises the glass substrate and a layer of the polyimide resin formed on the glass substrate:
the polyamide resin: a polyimide resin which is formed of a repeating unit that is represented by the following Formula (1) and includes residues (X) of tetracarboxylic acids and residues (A) of diamines and in which 50% by mole or greater of a total number of the residues (X) of tetracarboxylic acids is formed of at least one group selected from the group consisting of groups represented by the following Formulae (X1) to (X4) and 50% by mole or greater of a total number of the residues (A) of diamines is formed of at least one group selected from the group consisting of groups represented by the following Formulae (A1) to (A7): 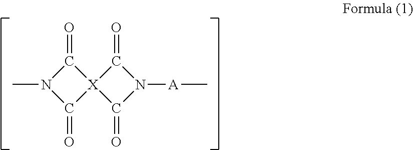
in Formula (1), X represents a tetracarboxylic acid residue obtained by removing a carboxy group from tetracarboxylic acids and A represents a diamine residue obtained by removing an amino group from diamines;

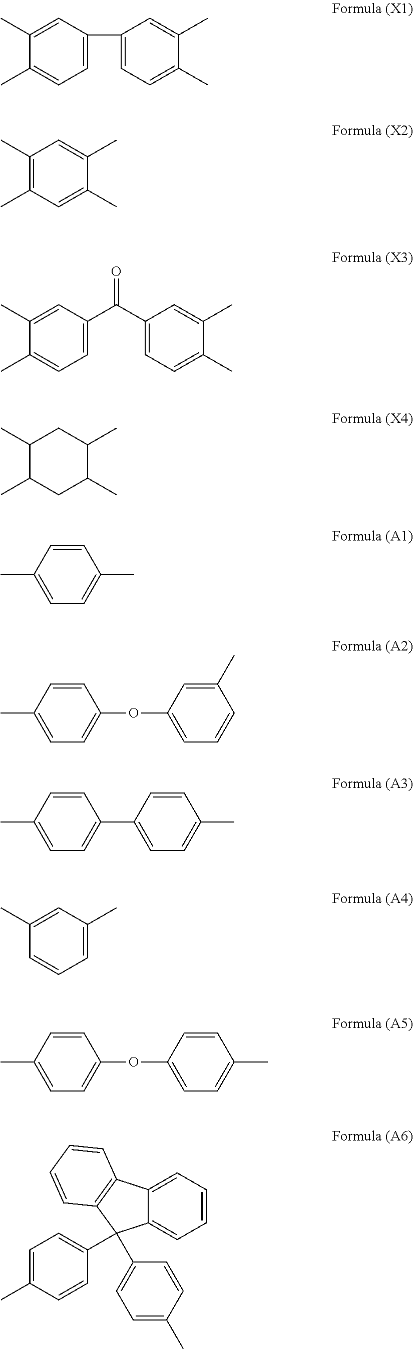

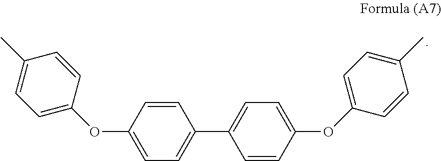

12. A method for producing an electronic device, comprising:
a member forming step of forming an electronic device member on a glass substrate surface on which the polyimide resin is not laminated, in the glass laminate according to claim 5, thereby obtaining an electronic device member-attached laminate; and
a separation step of removing the support glass from the electronic device member-attached laminate, thereby obtaining an electronic device which includes the flexible substrate and the electronic device member.
